(19) United States
(12) Patent Application Publication
(10) Pub. No.: US 2012/0159596 A1
(43) Pub. Date: Jun. 21, 2012

(54) BROWSER-BASED BACK-END MANAGEMENT SYSTEM FOR A CONCENTRATED PHOTOVOLTAIC (CPV) SYSTEM

(75) Inventors: Roeland Vandevelde, American Canyon, CA (US); Wayne Miller, Los Altos, CA (US); Brian Hinman, Los Gatos, CA (US)

(73) Assignee: GREENVOLTS, INC., FREMONT, CA (US)

(21) Appl. No.: 13/227,695

(22) Filed: Sep. 8, 2011

Related U.S. Application Data
(60) Provisional application No. 61/424,537, filed on Dec. 17, 2010.
(60) Provisional application No. 61/424,515, filed on Dec. 17, 2010.
(60) Provisional application No. 61/424,518, filed on Dec. 17, 2010.
(60) Provisional application No. 61/424,493, filed on Dec. 17, 2010.

(51) Int. Cl. H04L 9/32; G06F 15/16

(52) U.S. Cl. 726/7; 726/3; 709/203

(57) ABSTRACT

Each of the CPV arrays at a solar site is coupled with a different system control point (SCP) to be communicatively connected to a central backend management system associated with that solar site. The management system is configured to present a plurality of user interfaces via the Internet to a browser of a user's client device to enable the user to navigate to and then 1) view information for various components and 2) send a command to perform an action for various components for the various components associated with the CPV arrays. The plurality of user interfaces presented to the user based on the management system having authenticated the user as being allowed to view the information related to the CPV array.

### RELATED APPLICATIONS

This application claims the benefit under 35 USC 119 of and priority to U.S. Provisional Application titled “INTEGRATED ELECTRONICS SYSTEM” filed on Dec. 17, 2010 having application Ser. No. 61/424,537, U.S. Provisional Application titled “TWO AXIS TRACKER AND TRACKER CALIBRATION” filed on Dec. 17, 2010 having application Ser. No. 61/424,515, U.S. Provisional Application titled “PV CELLS AND PADDLES” filed on Dec. 17, 2010 having application Ser. No. 61/424,518, and U.S. Provisional Application titled “ISIS AND WIFI” filed on Dec. 17, 2010 having application Ser. No. 61/424,493.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### FIELD

Embodiments of the present invention generally relate to the field of solar power, and in some embodiments, specifically relate to using a browser to access information and control operations of a solar site.

### BACKGROUND

A solar site may include many devices. Each of these devices may be able to provide useful information. There has not been an efficient technique to manage this useful information.

### SUMMARY

Various methods and apparatus are described for a concentrated photovoltaic (CPV) system. In an embodiment, a browser in a client computing system may be used to enable accessing information associated with a solar site using the Internet. The client computing system is associated with a backend central management system, both communicatively connected to the Internet. The client computing system may be located remotely from a location of the solar site. The solar site may include a plurality of concentrated photovoltaic (CPV) arrays. Each CPV array is coupled with a different system control point (SCP) communicatively connected to the Internet to be in communication with the central backend management system. Communication between an SCP and the central backend management system is carried out over a secured communication channel, including a secured communication channel that is based on Hypertext Transfer Protocol Secure (HTTPS). The central backend management system is configured to present a plurality of user interfaces via the Internet to a user to enable the user to navigate to various components associated with a CPV array and to view information related to the CPV array. The plurality of user interfaces are viewable with the browser and are presented to the user based on the central backend management system having authenticated the user as being allowed to view the information related to the CPV array.

### BRIEF DESCRIPTION OF THE DRAWINGS

The multiple drawings refer to the embodiments of the invention.

FIG. 1 illustrates a block diagram of an example computing system that may use an embodiment of one or more of the software applications discussed herein.

FIG. 2 illustrates a diagram of an embodiment of a network with a central backend management system communicating with multiple solar sites.

FIGS. 3A, 3B, and 3C illustrate diagrams of an embodiment of a pair of concentrated photovoltaic (CPV) paddle assemblies that may be installed at a solar site.

FIG. 4 illustrates a diagram of an embodiment of the physical and electrical arrangement of modules in a representative tracker assembly.

FIG. 5 illustrates diagrams of an embodiment of a solar site with multiple CPV arrays.

FIG. 6 illustrates a diagram of an embodiment of a wireless communication set up at a solar site.

FIG. 7 is a diagram that illustrates an example login user interface associated with the central backend management system.

FIG. 8 is a diagram that illustrates an example a user interface associated with the central backend management system.

FIG. 9 is a diagram that illustrates an example main dashboard user interface that displays power/energy information.

FIG. 10 is a diagram that illustrates an example main dashboard user interface that displays the power and DNI information.

FIG. 11 is a diagram that illustrates an example main dashboard user interface that displays the tracker information.

FIG. 12 is a diagram that illustrates an example main dashboard user interface that displays the camera information.

FIG. 13 is a diagram that illustrates an example main dashboard user interface that displays the maintenance information.

FIG. 14 is a diagram that illustrates an example main dashboard user interface that displays the SCP and inverters information.

FIG. 15 is a diagram that illustrates an example main dashboard user interface that displays paddle, module, and receivers information.

FIG. 16 is a diagram that illustrates an example main dashboard user interface that displays the alert information.

FIG. 17 is a diagram that illustrates an example main dashboard user interface that displays the performance information.

FIG. 18 is a diagram that illustrates an example main dashboard user interface that displays the manufacturing data and the configuration information.

FIG. 19 is an example system diagram for a central backend management system.

FIG. 20 is a flow diagram that illustrates an embodiment of a process that may be used to view performance-related information from a solar site.

FIG. 21 is a flow diagram that illustrates an embodiment of another process that may be used to view configuration-related information from a solar site.

FIG. 22 is a flow diagram that illustrates an embodiment of another process that may be used to view service-related information from a solar site.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific voltages, named components, connections, types of circuits, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references (e.g., a first array, a second array, etc.) may be made. However, the specific numeric reference should not be interpreted as a literal sequential order but rather interpreted that the first array is different than the second array. Thus, the specific details set forth are merely exemplary. The specific details may vary from and still be contemplated to be within the spirit and scope of the present invention.

In general, various methods and apparatus associated with accessing information from a solar site by using a browser in a client computing system and connecting to a central backend management system using the Internet are discussed. In an embodiment, information is received from a user indicating that the user wants to view information related to a plurality of concentrated photovoltaic (CPV) arrays located at a remote solar site. Each of the CPV arrays is coupled with a different system control point (SCP) communicatively connected to the Internet and in communication with a central backend management system.

The information received from the user includes authenticating information sent over the Internet based on the user using the browser in the client computing system. The authenticating information is verified by the central backend management system. The user may also be verified to confirm that the user is allowed to view the information related to the plurality of concentrated photovoltaic (CPV) arrays.

When the user is authenticated, the central backend management system may present a user interface that includes overview information of one or more solar sites included in a portfolio that the user is associated with. The central backend management system may present a user interface that includes options to enable the user to specify a solar site in the portfolio and a component of the solar site that the user wants to view the information. Responsive to the user specifying the portfolio and the component, the central backend management system may present a user interface that displays information related to the specified component. Other user interfaces may also be presented. All of the user interfaces presented by the central backend management system may be viewable with the browser.

### Client Computing System

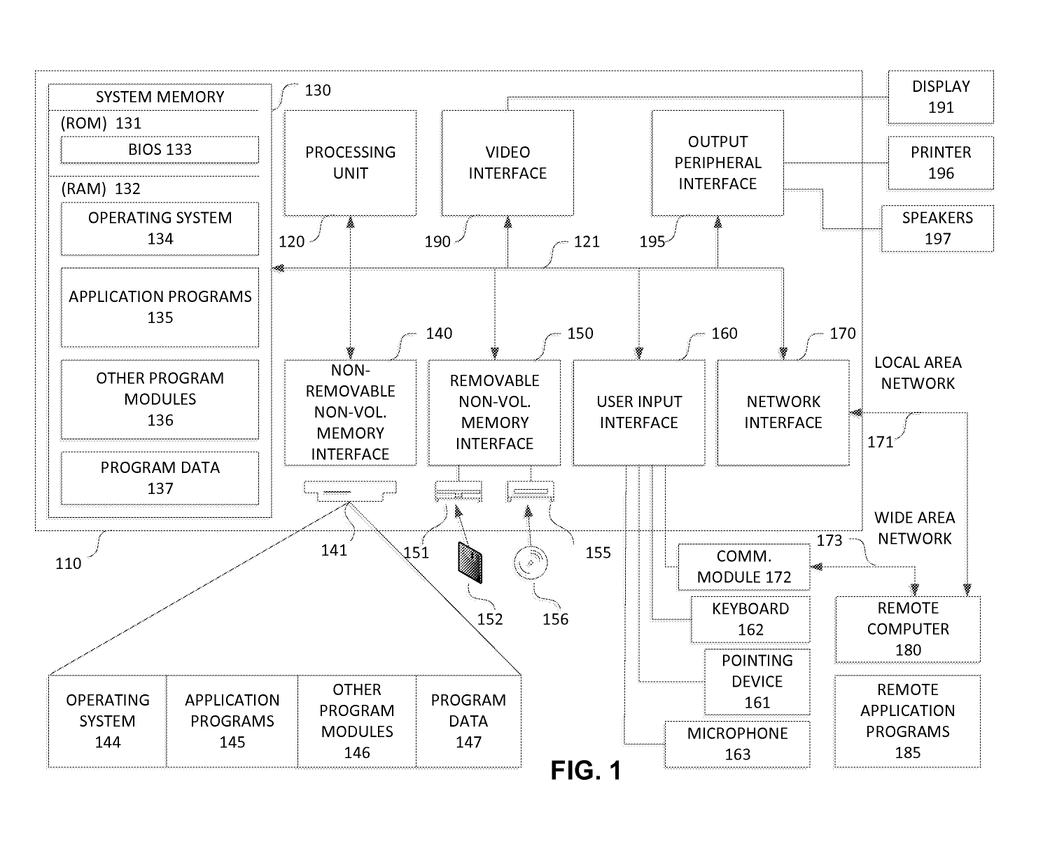

FIG. 1 illustrates a block diagram of an example computing system that may use an embodiment of one or more of the solar power generation site and wireless local area network concepts discussed herein. The wireless LAN allows transmitting commands, parameters, and other information between each of the two axis tracker mechanisms and its various components without having to route cables to those tracker mechanisms.

### Solar Site Network

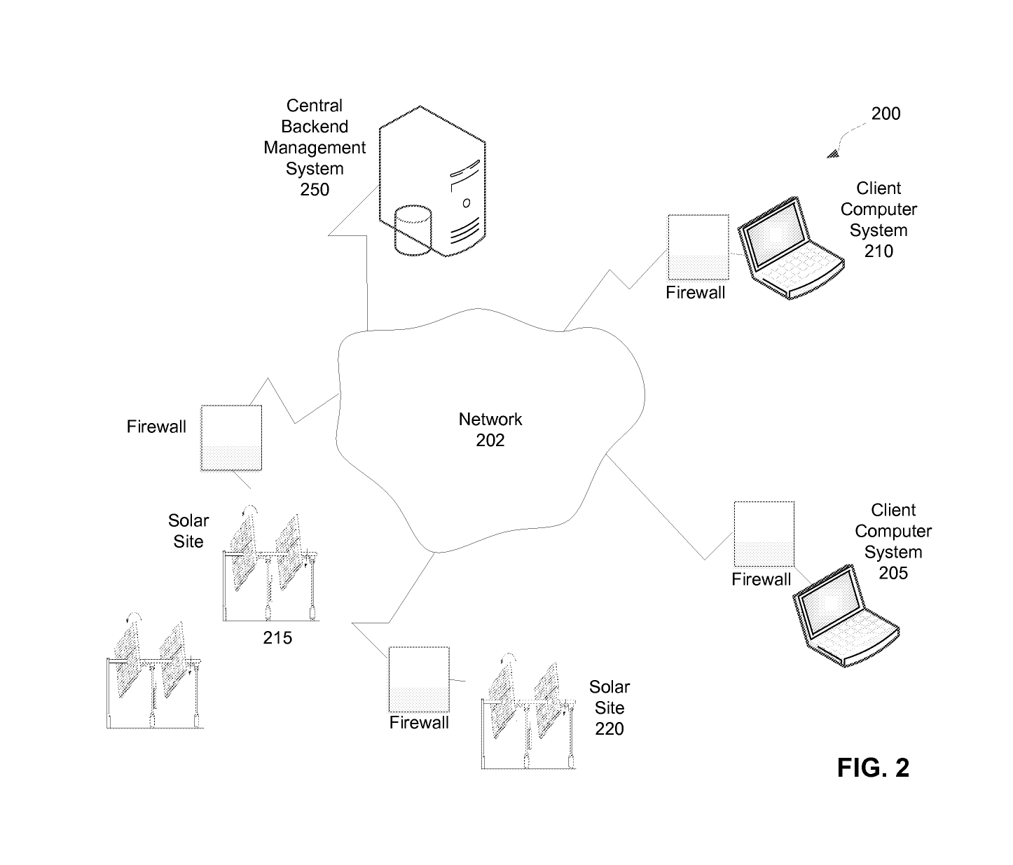

FIG. 2 illustrates a diagram of an embodiment of a network with a central backend management system communicating with multiple solar sites. Diagram 200 may include a network 202, which may be the Internet. A central backend management system 250 may be coupled to the network 200 and configured to enable users to control and manage solar sites from anywhere over the network 200. In the current example, solar sites 215, 220 may be coupled to the network 202. There may be a firewall 216 or 221 at each of the respective solar sites 215, 220.

Each of the solar sites 215, 220 may include many photovoltaic arrays. Each of the photovoltaic arrays is contained in a two-axis tracker mechanism that generates an AC voltage output. Tracker motion control circuitry and electrical power generating circuitry are locally contained on the two-axis tracker mechanism. Each of the photovoltaic arrays is configured with a GPS circuitry to provide position information of the respective photovoltaic array at the solar site. Each of the photovoltaic arrays is configured with wireless communication circuitry to communicate information associated with the respective photovoltaic array to the central backend management system 250.

A user may use a client computing system 205 or 210 to connect to the central backend management system 250 to manage the solar site 215 and/or the solar site 220. Each of the client computing systems 205, 210 may be associated with a browser software to enable the users to use the Internet to access webpages associated with the central backend management system 250. There may be a firewall 206 or 211 associated with each of the client computing systems 205 and 210.

The central backend management system 250 may be configured to provide a large scale management system for monitoring and controlling many solar sites. From anywhere, a user with authorization and privileges can connect to the network 202 and monitor and control the paddles and solar site where the paddles are located. Each solar site may also have a video camera configured to provide information about what is happening at the solar site. The central backend management system 250 may use software as a service type model with secure networking to allow remote controlling and monitoring of the components at the solar site over the Internet. The software as a service can be software that is deployed over the Internet and is deployed to run behind a firewall on a private network. With the software as a service, application and data delivery is part of the utility computing model, where all of the technology is in the “cloud” accessed over the Internet as a service. The central backend management system 250 may be associated with a database, which may be configured to store information received from the various solar sites.

Using the client computing system 210, a user may be able to view information about the solar site including, for example, the signal strength of the wireless router for every CPV array, the temperature of the inverter board, the position of every axis for every CPV array in relation to the sun, whether each axis of a CPV array is tracking, the accuracy of the tracking, the date and time when the tracker of a CPV array was last calibrated, basic predefined graphs on the portfolio, site, section, and array or string dashboard as a graph for a certain time period (e.g., one hour, one day, one week, one month, one year, etc.), the energy production performance as related to all the strings of a CPV array or all the substrings of a string, etc.

### Concentrated Photovoltaic (CPV) Array at a Solar Site

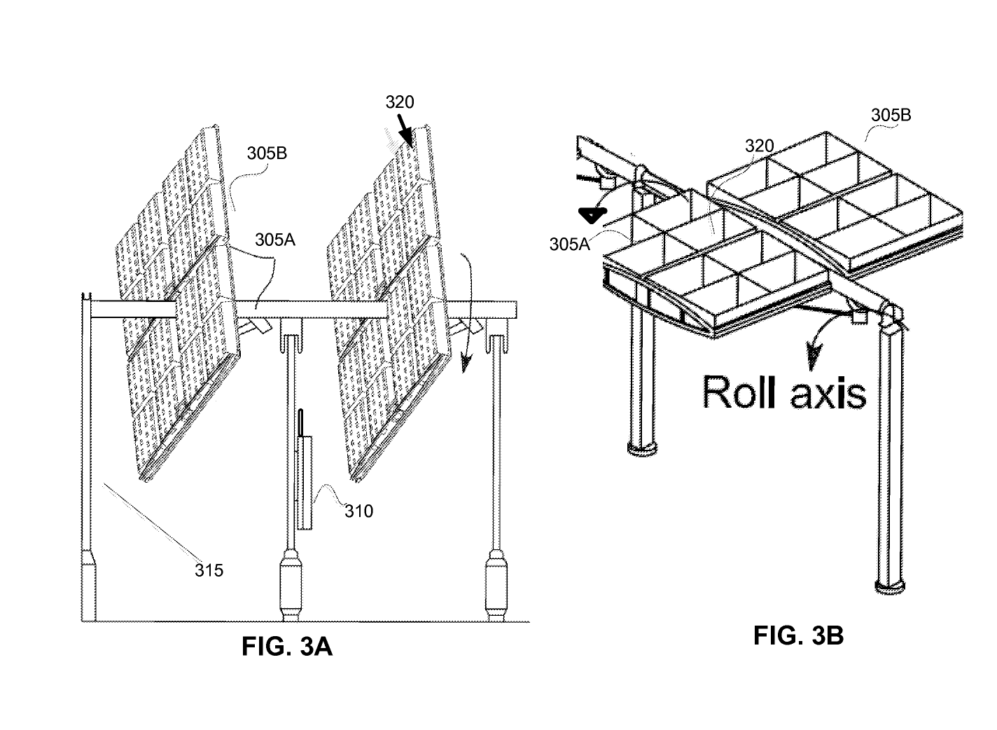

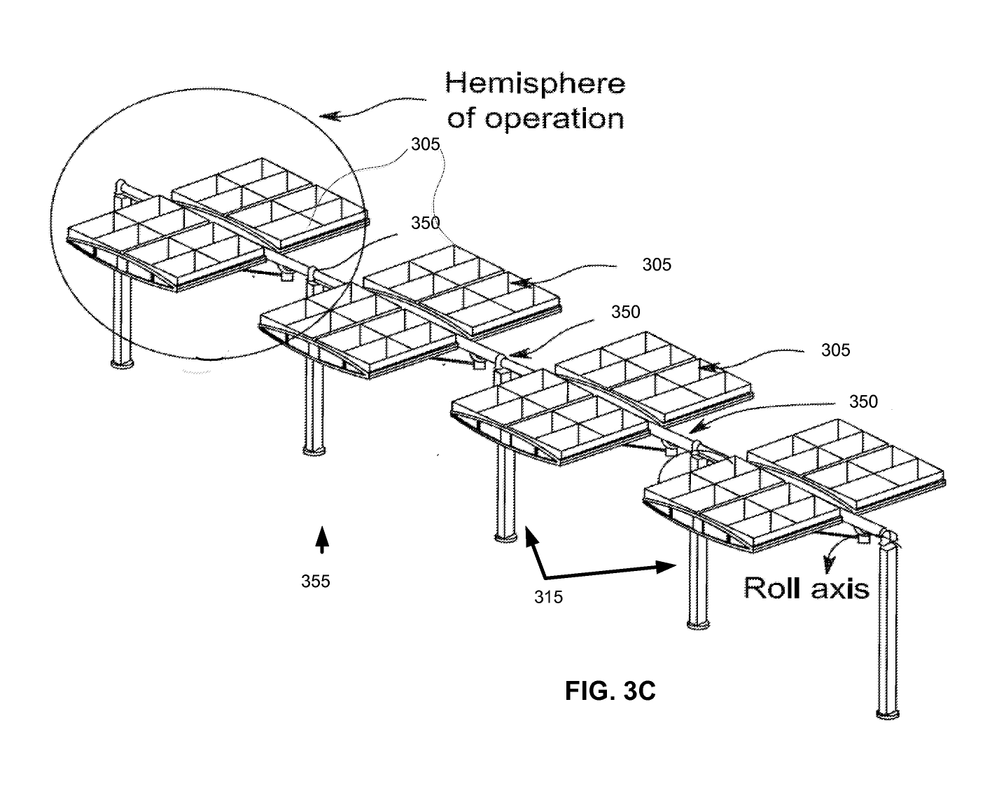

FIGS. 3A, 3B, and 3C illustrate diagrams of an embodiment of a pair of CPV paddle assemblies that may be installed at a solar site. Illustrated in FIG. 3A is a paddle pair 305A and 305B which has its own section of roll beam and own tilt axle. This may allow independent movement and optimization of the paddle pair 305A, 305B with respect to other paddle pairs in a tracker assembly. The movement of the paddle pair 305A, 305B may be limited within an operational envelope. The paddle pair 305A, 305B may be supported by a stanchion 315 and may be associated with an integrated electronics housing of a local system control point (SCP) 310. As illustrated in FIG. 3B, each of the paddles 305A, 305B may include eight (8) modules of CPV cells 320. The module may be the smallest field replaceable unit of the CPV paddle 305A or 305B. The paddles 305A, 305B and their respective modules may be assigned manufacturing data when they were manufactured. When the paddles 305A, 305B and their respective modules are installed in a solar site, their position information and associated manufacturing data may be recorded and stored in a manufacturing data database. The manufacturing data database may be associated with the central backend management system 250.

Illustrated in FIG. 3C is one 16 Kilowatts (KW) CPV solar array that includes eight (8) CPV paddle assemblies 305 mounted on four (4) tilt axle and a common roll beam assembly 350. As illustrated, the tracker assembly 355 is supported by five (5) stanchions, including the three shared stanchions in the middle and a non-shared stanchion at each end. At the shared and non-shared stanchions, the ends of the conical roll beams of each roll beam couple, for support, into the roller bearings. The tracker assembly 355 includes the conical shaped sections of roll beam (fixed axle) with multiple paddle-pair tilt-axle pivots perpendicular to the roll beam.

The CPV paddle assemblies 305 are associated with the SCP 310. In general, there may be one SCP for each CPV paddle assembly (also referred to as a CPV array). For some embodiments, the SCP 310 may include motion control circuits, inverters, ground fault circuits, etc. The SCP 310 may be an integrated electronics housing that is a weather-tight unit. The SCP 310 controls the movement of the tracker assemblies 355, receives DC power from the modules, converts the DC power to AC power, sends the AC power to a power grid, and collects and reports performance, position, diagnostic, and weather data to the central backend management system 250.

### Tracker Assembly for a CPV Array at a Solar Site

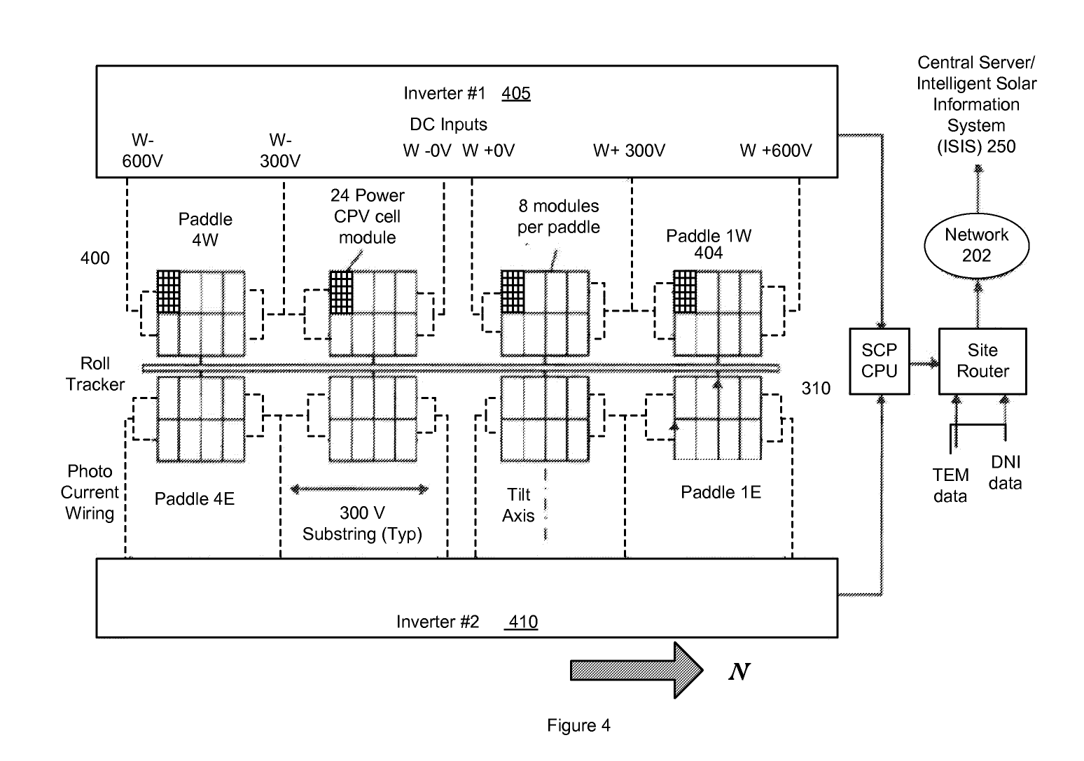

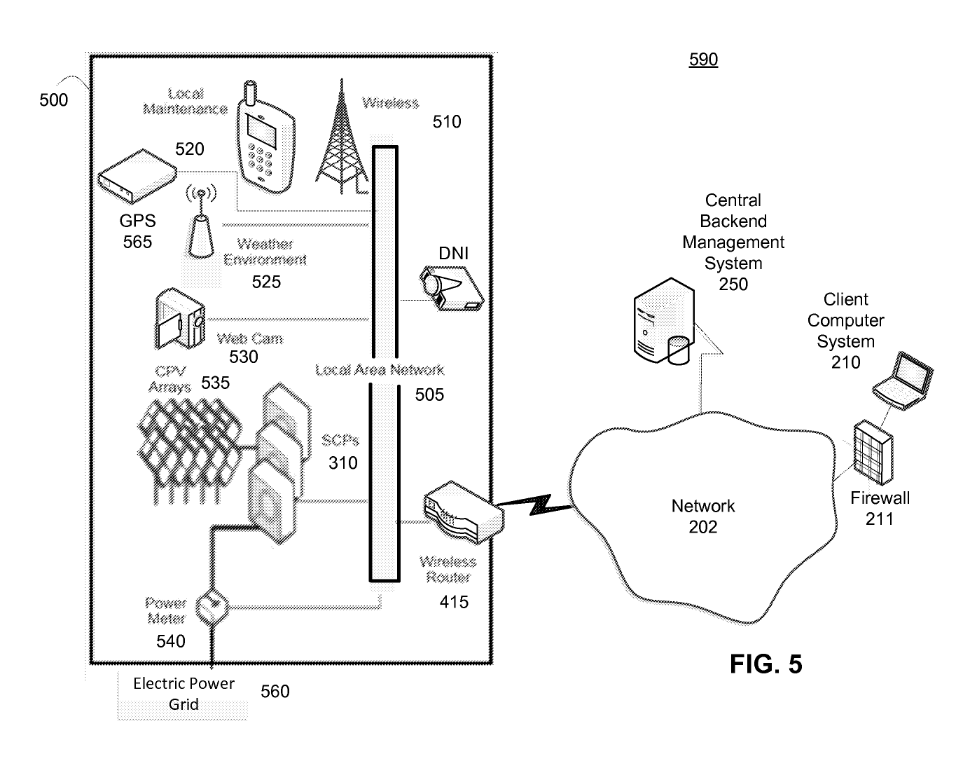

FIG. 4 illustrates a diagram of an embodiment of the physical and electrical arrangement of modules in a representative tracker assembly. In diagram 400, there is one CPV array with eight paddles 430 and two inverters 405 and 410. There are also twenty-four power units per module, eight modules per paddle, two paddles per tilt axis, and four independently-controlled tilt axes per common roll axis. The bi-polar voltage from the set of paddles may be, for example, a +600 VDC and a −600 VDC making a 1200 VDC output coming from the CPV modules. The CPV module array may be a string/row of PV cells arranged in an electrically series arrangement of two 300 VDC panels adding together to make the +600 VDC, along with two 300 VDC panels adding together to make the −600 VDC. Also illustrated in FIG. 4 are the SCP 310, the network or the cloud 202, and a router 415. As will be described with FIG. 5, wireless communication is used to transmit information between the SCP 310 and the router 415. It may be noted that the router 415 also receives direct normal irradiation (DNI) data 420 and temperature/weather data 425. It may also be noted that the central backend management system 250 illustrated in FIG. 2 may also be referred to as an Intelligent Solar Information System (ISIS) or central backend management system 250. The CPV paddles may be arranged in a North South direction, and the CPV modules may be arranged in an East West direction.

### Local Area Network (LAN) at a Solar Site

FIG. 5 illustrates diagrams of an embodiment of a solar site with multiple CPV arrays. Solar site 500 may include a local area network (LAN) 505. Connected to the LAN 505 is radio assembly 510, GPS 565, maintenance hand-held device 520, camera 530, SCPs 310, weather station 525, and power meter 540.

The SCPs 310 are located on the CPV arrays 535. As illustrated in FIG. 3C, there may be one SCP 310 for each of the CPV arrays 535. Each CPV array 535 may include eight (8) paddles, and there may be eight (8) modules per paddle. The SCP 310 may include motion control logic, inverter logic, etc. For example, the motion control logic may allow transitioning the paddles from an operational mode to a stow mode to prevent damage in adverse weather condition (e.g., gust wind, storm, etc.), and the inverter logic may allow converting DC power to AC power. A module in a single SCP may be configured to continuously monitor a local weather station relative to that solar site and broadcast the weather across the LAN to the rest of the SCPs.

For some embodiments, a secured communication channel using Hypertext Transfer Protocol Secure (HTTPS) may be used for transmitting information between the SCP 310 and the central backend management system 250 over the network 202. The SCP 310 may use HTTPS POST to send performance data to the ISIS 250. The SCP 310 may ping the central backend management system 250 periodically (e.g., every one minute) even when the SCP 310 has no data to report. For some embodiments, the central backend management system 250 may respond with acknowledgement in response to the HTTP POST and can optionally send commands to the SCP 310, requests the SCP 310 to maintain a more frequent or permanent connection, throttle the speed of the SCP messages, etc.

For some embodiments, the SCP 310 only has outbound connections and no inbound open connection ports. The SCP 310 may control all the traffic that is transmitted to the central backend management system 250. It should be noted that the central backend management system 250 does not make inbound calls to the SCP 310. The SCP 310 communicates with all of the other devices (e.g., camera 530, GPS 365, etc.) connected to the LAN 505 and polls data from these devices. The SCP 310 may be associated with a network name and a MAC address, and the SCP 310 may be registered with an on-site DNS server. At predetermined time intervals, the SCP 310 may send power performance data, motion control data, image data, weather data, direct normal irradiation (DNI) data from the Normal Incidence Pyrheliometer (NIP), etc. to the central backend management system 250. The SCP 310 may include wireless circuitry to transmit information to the central backend management system 250 using wireless communication via the wireless router 415.

The LAN allows faster communications between the devices located at the solar site than when those devices communicate over the Internet with the central backend management system 250. The LAN also includes one device at the site that can provide its information or functionality across the LAN to all of the two-axis tracker mechanisms located at that solar site.

Thus, as discussed above, measured parameters common across the solar site, including DNI and local weather, are 1) detected by a local detector, 2) retrieved by a local device or 3) a combination of both, and then broadcast as internal solar site communications over the LAN to all of the different SCPs at the site. The communications are faster and more reliable because Internet access to such information may occasionally become unavailable from time to time. The measured parameters common across the solar site need only a single detector device rather than one device per two-axis tracker mechanism.

A large number of software packages are resident and hosted in the SCP 310. Some of these may include SCP bi-directionally messaging posts in Extensible Markup Language (XML) to the HTTP(s) server, SCP initiating requests to be commissioned, SCP creating a TLS socket connection to Socket Dock and streams XML, SCP accepting the TLS socket connection to receive XML commands, and many others. The software packages may also be a combination of hardware logic working with programmed or coded instructions.

The local video camera 530 may be used to survey the plurality of CPV arrays and to capture video streams/images at the solar site 500. The images captured by the video camera 530 may be polled by the SCP 310 at predetermined time intervals. It may be noted that the video camera 530 can be configured to not send the images to the SCP 310 until the SCP 310 requests for them. The images may then be sent by the SCP 310 to the central backend management system 250. The image format of the video camera 530 may need to be converted into an XML supported format (e.g., base64) and sent to the central backend management system 250 with the data-protocol framework. The images may be time-stamped with the same clock as all of the other SCP data. This allows the central backend management system 250 to correlate the images and the performance data of the various CPV arrays 535. For some embodiments, when the network 202 is not available, the SCP 310 may buffer the video stream/image data and send them to the central backend management system 250 when the network 202 becomes available. The SCP 310 may send the images to the central backend management system 250 at certain time interval (e.g., every five seconds). The video streams/images may be stored by the central backend management system 250 in the associated database. For example, the stored video streams/images may be used to correlate with power/energy performance data during problem determination. There may be one or more video camera 530 at the solar site 500. When there are multiple video cameras 530, the streaming videos/images captured by each video camera may be polled by a different SCP.

Each of the CPV arrays 535 may be associated with a GPS 565. The GPS 565 is configured to provide positioning information for the associated CPV array 535 including the longitude and latitude or coordinate information. For example, in commissioning a CPV array 535, the SCP 310 may extract the positioning information from the GPS 565 and transmit it to the central backend management system 250. For some embodiments, the logic for the GPS 565 may be built into the SCP 310.

The weather station 525 may be used to collect local weather information at the solar site 500. That weather information may be collected by the SCP 310 and then transmitted to the central backend management system 250. A solar power meter may be on site to connect to a SCP or wirelessly itself in. The solar power meter may be connected to the LAN 505 using wireless communication with the LAN to. The solar power meter may measure an amount of DNI and broadcast updates of the measured amount of DNI and the time of that measurement, all of which are. The updates may be communicated over the LAN 505 to the other SCPs and back eventually transmitted to the central backend management system 250. Local operators may use the maintenance hand-held device 520 to communicate with the other devices in the LAN 505. The power meter 540 is coupled to a power station 560 and is configured to measure power generated by the CPV arrays 535 and distributed to the power grid 560. The power grid 560 may be associated with a client who purchases the power generated by the solar site 500. In this example, the client is Pacific Gas and Electric Company (PG&E). The solar site 500 may include one site wireless router 415 and one or more radio assemblies 510 to enable the SCP 310 to communicate with the central backend management system 250. The combination of the solar site 500 (and other solar sites), the central backend management system 250, the client computing system 210 with its browser (and other client computing systems) may be referred to as a solar power generation and management system.

### Wireless Communication Set Up at a Solar Site

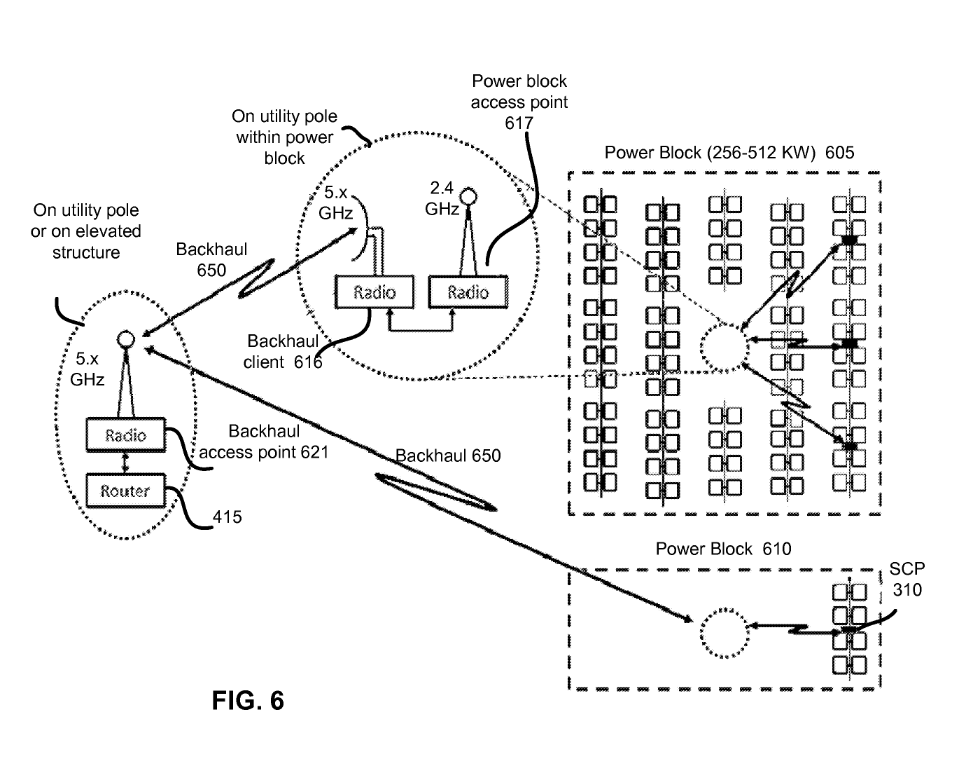

FIG. 6 illustrates a diagram of an embodiment of a wireless communication set up at a solar site. The solar site 500 may include multiple power blocks 605, 610. The power block 605 may be associated with a LAN 505 and may include multiple CPV arrays 535. The power block 605 may also be associated with the radio assembly 510, illustrated in FIG. 5. The radio assembly 510 (also referred to as a power block radio assembly 510) may be installed on a utility pole within the power block 605. For some embodiments, the radio assembly 510 may include a power block access point 617 and a back haul client 616 and an enclosure that contains connect for radio. The enclosure may include wiring connector, AC outlets, etc. and may be mounted at the bottom of the utility pole. The power block access point 617 may be a 2.4 GHz wireless access point, and the back haul client 616 may be a 5 GHz wireless access point. The antennas associated with the power block access point 617 and the back haul client 616 may be mounted onto a yardarm that is mounted at the top of the utility pole with network cables running from the enclosure from the bottom to the top of the utility pole.

The solar site 500 may also include a backhaul radio assembly 620, which may be installed on a utility pole or an elevated structure. The backhaul radio assembly 620 may include a backhaul access point 621 and the router 415. The backhaul access point 621 is coupled with the backhaul client 616 from each of the power blocks 605, 610 in the solar site 500 over a backhaul network 650. For example, the information collected by the SCP 310 from one or more of the devices connected to the LAN 505 and collected by the SCP 310 may be transmitted from the SCP 310 (using its internal wireless circuitry) to the power block radio assembly 510, over the backhaul network 650. The information may then be relayed to the backhaul network 650, the backhaul radio assembly 620 and its router 415, to the network 202, and eventually to the central backend management system 250.

From behind a firewall, the SCP 310 communicates with the central backend management system 250 over the Internet (as illustrated in FIG. 2). The SCP 310 may keep this communication open, (i.e., the socket connection) open until the protocol specific end tag is received. This creates a persistently open outbound connection coming from the SCP 310 out to the central backend management system 250 to work around the firewall at the SCP 310. From a high level, the SCP command architecture is a HTTPS client/server that exchanges XML messages constrained by a specific schema. The central backend management system 250 sends XML commands through a TLS encrypted channel and expects XML responses from the SCP 310. Both the central backend management system 250 and the SCP 310 follow the HTTPS protocol requiring the appropriate headers. HTTPS includes encryption and authentication. HTTPS requires both validation of the source and the receiver of the Internet communications, which can identify the individual SCPs at each solar site by their unique ID embedded in their HTTP communication. The information communicated between the SCPs and the central backend management system 250 may be encrypted.

### Remote Management of the Solar Site

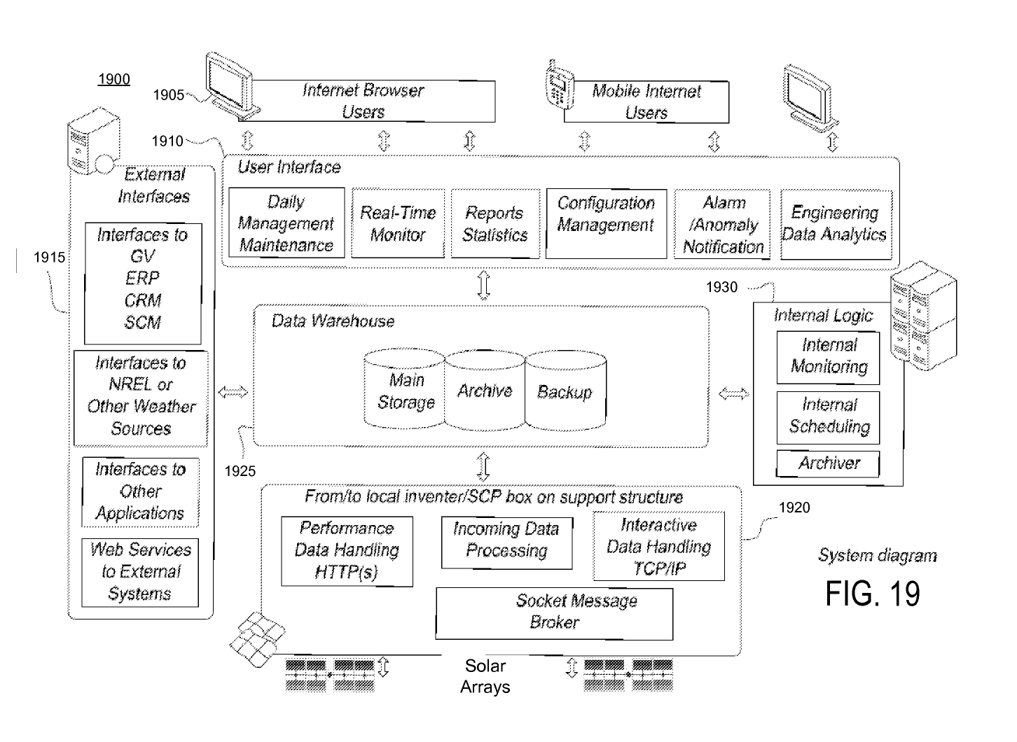

As described in FIG. 2, a user may use browser software (e.g., Firefox, Internet Explorer, etc.) installed on the client computing system 205 to connect to the central backend management system 250 via the network or Internet 202. The user may access webpages associated with the central backend management system 250 to view information available from the solar site 215. The user may also use the same connection to manage the solar site 215. For some embodiments, the user may need to register with the central backend management system 250 and be authorized to access information related to a specific solar site. The use of the browser software by the client computing systems to login to the central backend management system 250 to access information from the solar sites is also illustrated in the system diagram of FIG. 19.

The central backend management system 250 may be hosted on one or more servers. Users with mobile or non-mobile client computing systems can also connect to the central backend management system 250 via the Internet. The browser-based access through the central backend management system 250 may be configured to allow near real-time system status and operational control of the arrays at the solar site. The central backend management system 250 is configured to have user authentication features, user search and browse features, command schema for control of components, monitoring of components, and alert notification on components.

The central back-end management system 250 is configured for monitoring and controlling the solar sites in a scalable manner. The central backend management system 250 controls and manages the concentrated photovoltaic (CPV) system from anywhere over a network, such as the Internet. The monitoring and intelligence capability programmed into the central backend management system 250 is not for the most part, located in the end-points of the user's client computing system or local integrated electronic housings for the local system control points; rather the monitoring and intelligence capability is programmed into the central backend management system 250.

The central backend management system 250 collects data from a number of parameters from all of the solar arrays at all of the solar sites. The user obtains network access to one or more sites owned by the user by accessing the central backend management system 250 as a hosting facility. For some embodiments, a virtual private network may be maintained between each solar site and the central backend management system 250. SSL type security for the network along with an authorized user list may be utilized to secure the network between the client computing system over the Internet and to the hosting facility. For some other embodiments, communication between the solar site and the central backend management system 250 may be based on HTTPS. Other Similar security protocols may be employed between the central backend management system (the hosting facility) and each solar site. Thus, when the user wants to interact with or even monitor the solar site, the user can use the browser of the client computing system and connect to the central backend management system 250 instead of connecting directly to the SCP end-point at the solar site.

### Graphical User Interface

A set of user interfaces (also referred to as dashboards) served by the central backend management system 250 provides the user experience of an on-line solution for the entire solar system. These user interfaces enable on site set up and diagnostics, remote management and trouble shooting, historical data storage & retrieval, visual presentation of the remote set of solar generation facilities over a public wide area network to its intended audience, and much more.

For some embodiments, a set of graphical user interfaces (GUIs) may be presented to the user by the central backend management system 250 once the user is authenticated. Each of the GUIs may include options to enable the user to operate and control one or many solar sites that the user is associated with. The GUIs may include options to enable onsite set up and diagnostics, remote management and troubleshooting, historical data storage and retrieval, visual presentation of the solar sites, etc. For example, the user may be able to view signal strength of the wireless router for every CPV array, the temperature of the inverter board, the position of every axis for every CPV array in relation to the sun, whether each axis of a CPV array is tracking or not and the accuracy of the tracking, the date and time when the tracker of a CPV array was last calibrated, basic predefined graphs on the portfolio, site, section, and array or string dashboard as a graph for a certain time period (e.g., one hour, one day, one week, one month, one year, etc.), the energy production performance as related to all the strings of a CPV array or all the substrings of a string, etc. It may be noted that, by using the browser software, the user can access the information related to the solar site and manage the solar site via the central backend management system 250 rather than having to connect directly to a device (e.g., the SCP 310) at the solar site.

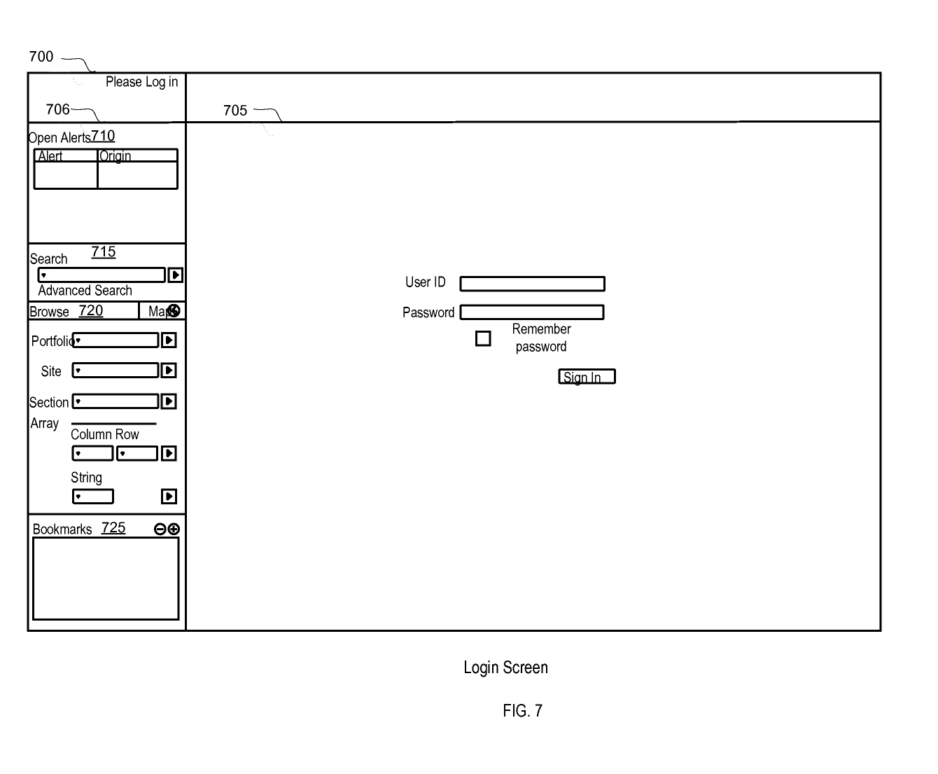

FIG. 7 is a diagram that illustrates an example login user interface associated with the central backend management system. Diagram 700 includes a main panel 705 and a side panel 706. The main panel 705 may include a section to enable a user to login to the central backend management system. There may be input areas for user identification (ID) and password. The user ID and passwords may be assigned to a user by a technical staff associated with the central backend management system. The side panel 706 may include an alert section 710, a search section 715, a browse section 720, and a bookmarks section 725.

The alert section 710 may be used to display alert information and to enable the user to view more details about certain alerts. The alert section 710 may allow the user to navigate to a particular alert by selecting or clicking on an alert name. The search section 715 may be used to enable the user to quickly search for information related to a component of a solar site that the user is associated with. The browse section 720 may be used to enable the user to browse information about a solar site by selecting parameters provided in pulled-down lists, thus enabling the user to drill down or access information at many different levels of details. The browse section 720 allows the user to navigate to the portfolio, the sites in the portfolio, the sections, arrays and individual strings in the solar site. When a navigation point (e.g., portfolio, site, section, array column, array row, and string) is selected, the activation arrow button 810 on the lower right of the browse section 720 may cause the appropriate dashboard to be displayed in the main panel 705. Each combination of navigation points may be associated with a different displayed graph in the panel. The side panel 706 may remain visible to the user regardless of where the user is in the process of managing the solar sites.

During the login process, the central backend management system 250 may perform multiple layers of authentication. The central backend management system 250 may allow a solar site within a portfolio to be managed by different users or group of users.

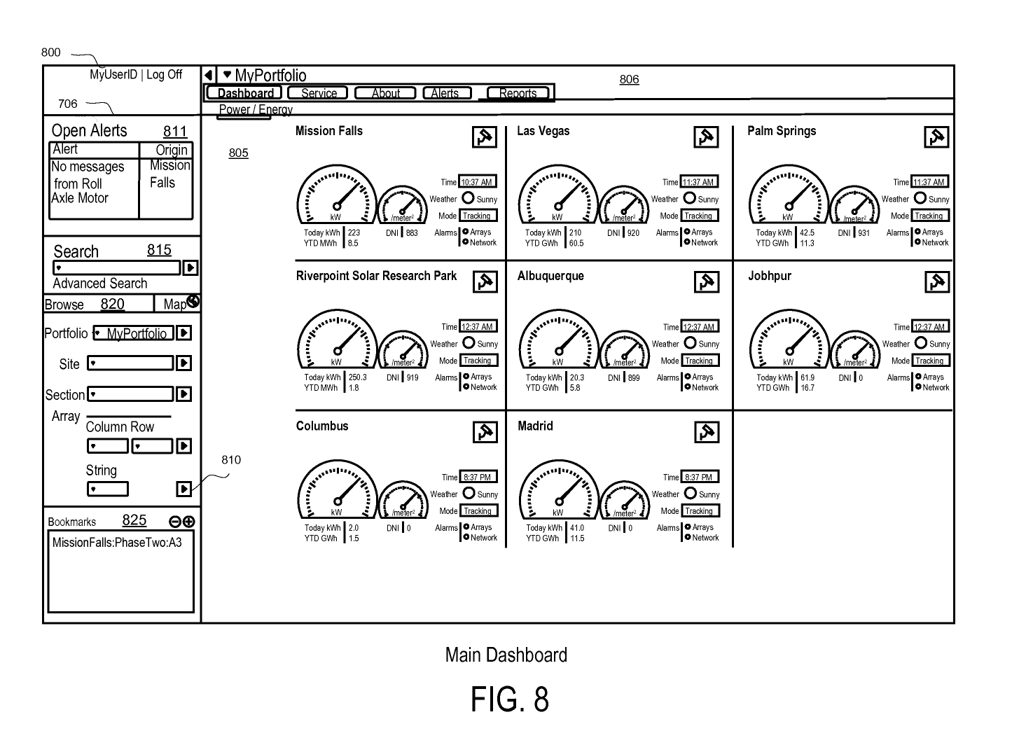

FIG. 8 is a diagram that illustrates an example a user interface associated with the central backend management system. Diagram 800 may be presented after the user logs in and is authenticated by the central backend management system 250. The diagram 800 includes a portfolio overview section 805 and dashboard tab section 806. The portfolio overview section 805 may display high-level or overview information about the solar sites in the portfolio of the user. The information may be displayed in a two dimensional array. The example in diagram 800 includes eight (8) solar sites—Mission Falls, Las Vegas, Palm Springs, Riverpoint Solar Research Park, Albuquerque, Jobhpur, Columbus and Madrid. It may be noted that even though these solar sites are located worldwide, the user may be able to manage and access information associated with these solar sites by connecting and logging into the central backend management system using the Internet.

As illustrated in FIG. 8, the overview information for each of the solar sites may include power/energy information, local time information, local weather information, alarm information, address information, video camera information, etc. The user may have the option of searching for a specific site, section, array or string and alternatively seeing the same information by drilling down the hierarchy of icons on the dashboard in order to view the drilled down site/array/string/tracker etc., overall status, alarm status, configuration information or manufacture information. The user may use the side panel 706 to drill down on to deeper levels of details about a particular solar site using browse options. Also in the side panel 706, the user may use the “+” button to save information in the favorite section for quick access to the same information (e.g., the energy information associated with a particular array of a solar site) at a subsequent time. An item in the favorite section may be a textual string that includes information about a particular site, section and array. A “−” button may be used to remove an item from the favorite section.

The central backend management system 250 may allow the user to define other users who can manage its solar site. The user may be able to add or remove portfolios, view all the solar sites in a portfolio, add and remove sites from a portfolio, etc. The user may be able to add or remove users that have any permission in the management of its portfolio via the central backend management system 250.

The dashboard tab section 806 includes dashboard tab, service tab, about tab, alerts tab and reports tab. Each of the tabs may be associated with one or more sub tabs. As will be described, each of the sub tabs may be associated with a different user interface and may present a different type of information or option to the user. Depending on how the user navigates the browse section 720 of the side panel 706, appropriate tab is activated and its associated sub tabs are available for the user to select. For example, when the dashboard tab is activated, the associated sub tabs power/energy, tracker, IV curves and camera are displayed. When the service tab is activated, the associated sub tabs maintenance, control and firmware are displayed. When the about tab is activated, the associated sub tabs configuration, network and components are displayed. When the reports tab is activated, the associated sub tabs performance and configurations are displayed. Selecting any of the sub tabs mentioned may cause information related to the sub tabs to be displayed in the main panel 705. For some embodiments, the user may use the browse section 720 to select a solar site displayed in the solar site overview section 805 to manage or access information related to that particular solar site.

The side panel 706 may include an alert section 811, a search section 815, a browse section 820, and a bookmarks section 825. The alert section 811 may be used to display alert information and to enable the user to view more details about certain alerts. The alert section 811 may allow the user to navigate to a particular alert by selecting or clicking on an alert name. The search section 815 may be used to enable the user to quickly search for information related to a component of a solar site that the user is associated with. The browse section 820 may be used to enable the user to browse information about a solar site by selecting parameters provided in pulled-down lists, thus enabling the user to drill down or access information at many different levels of details. The browse section 820 allows the user to navigate to the portfolio, the sites in the portfolio, the sections, arrays and individual strings in the solar site. When a navigation point (e.g., portfolio, site, section, array column, array row, and string) is selected, the activation arrow button 810 on the lower right of the browse section 820 may cause the appropriate dashboard to be displayed in the main panel 805. Each combination of navigation points may be associated with a different displayed graph in the panel. The side panel 806 may remain visible to the user regardless of where the user is in the process of managing the solar sites.

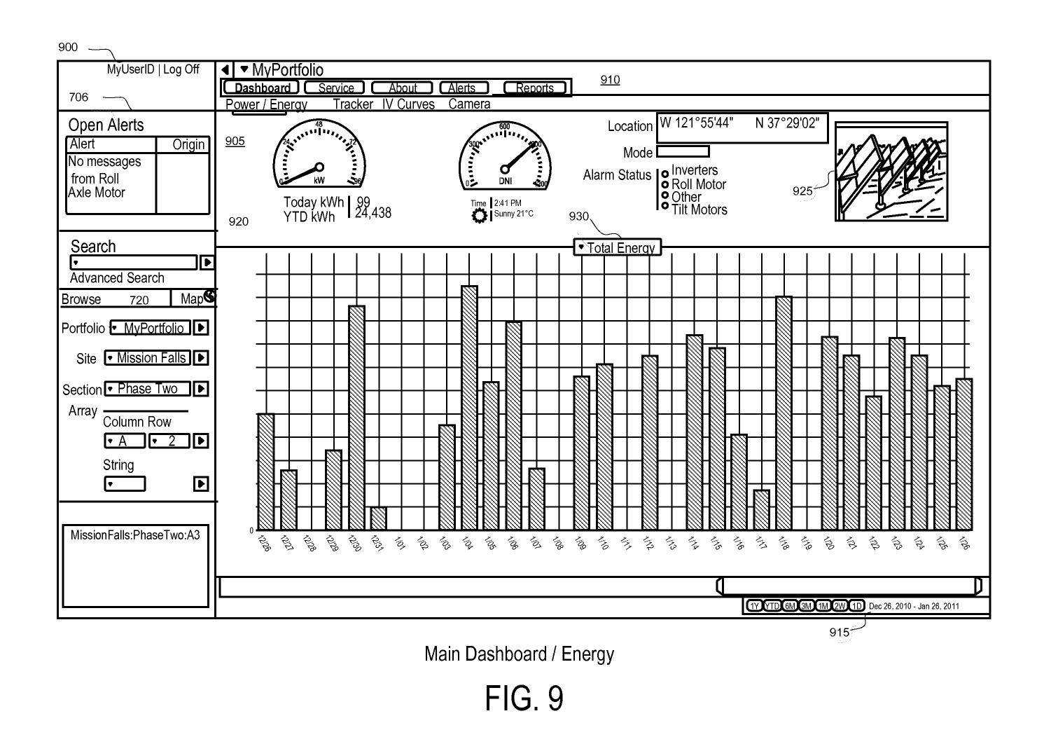

FIG. 9 is a diagram that illustrates an example main dashboard user interface that displays power/energy information. Diagram 900 may be presented after the user navigates the browse section 720 to select a solar site, section, array and string. It may be noted that the power/energy sub tab under the dashboard tab may be activated as a default.

The power/energy information is presented as a bar chart 920 with the vertical axis representing the total energy in kilowatts hour (kWh) and the horizontal axis representing the dates. The timeframe of the information displayed in the bar chart 920 is defaulted at one month. The lower right section 915 of the dashboard allows the user to select varying timeframes from one day to one year. In the current example, the diagram 900 also includes a video box 925 that shows a small streaming video of the solar site along with the time information, DNI information, weather information, current day and year-to-date energy information, alarm status, GPS location information, and mode information. The user may alternatively view the view of the information from total energy to power and DNI by selecting the pull down option 930.

Section 905 in the main panel of diagram 900 includes a gauge showing kWh per day and year to date, a gauge showing DNI, local time, the weather and temperature information, the latitude and longitude of the SCP 310. This section also shows the mode of the array (when an array is navigated to), an alert status area with changing LED type mode and a streaming video of the solar site.

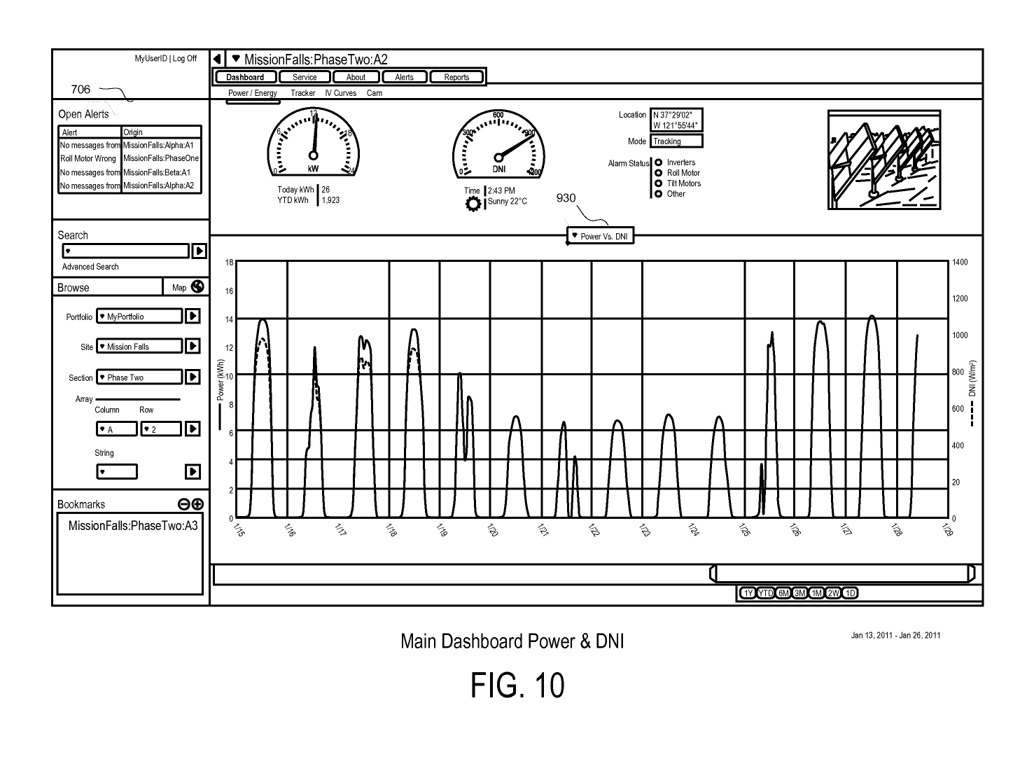

FIG. 10 is a diagram that illustrates an example main dashboard user interface that displays the power and DNI information. The power and DNI information illustrated provides a two-week timeframe view. The user may be able to check at a glance that an individual portfolio, site, section, array or string is producing energy as expected and that there are no problems. The user may be able to view near real time the performance of the solar site. The energy production information on the dashboard may include the energy produced since dawn and the energy produced since the beginning of the current year.

The central backend management system 250 may display data points on the displayed graph. The user may be able to view basic predefined graphs (e.g., power levels) on the portfolio, site, section, and array or string for a period of one hour, one day, one week, one month or one year. The user may specify an array and the data correlated with the data of the neighboring arrays.

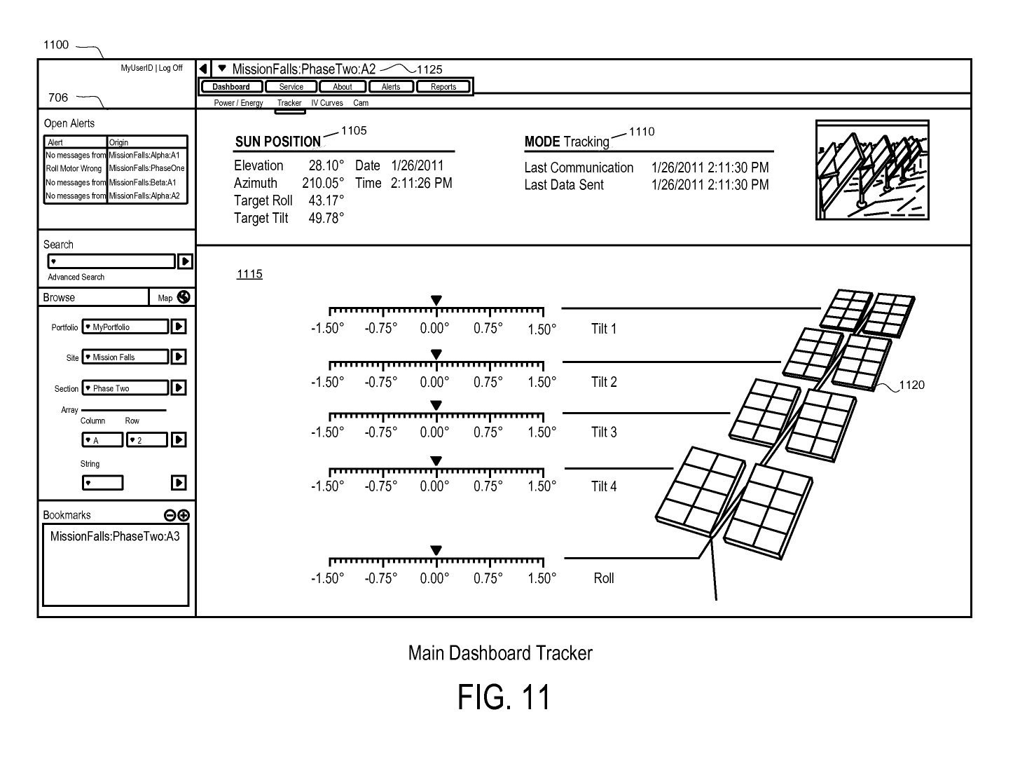

FIG. 11 is a diagram that illustrates an example main dashboard user interface that displays the tracker information. Diagram 1100 may be presented when the tracker sub tab under the dashboard tab is activated. The diagram 1100 includes the sun position information 1105, the mode information 1110, and the paddle pairs positioning information 1115. This may enable the user to view the paddle pairs and roll beam actual versus commanded positions. The dashboard with the tracker control capability reinforces the user's comfort level on the reliability, durability and accuracy of the dual tracking system by showing for every array a near real-time tracking status of various parameters. For example, the user will be able to view the position of every axis for every array in relation to the sun. The user may be able to see whether each axis of an array is tracking and the accuracy of the tracking. The date and time information about when the tracker of an array was last calibrated may be presented to the user. The user may also be able to view configuration information for a motor control board of a CPV array. An image 1120 of the roll beam and associated paddle pairs may be displayed to enable the user to view the position changes. It may be noted that the diagram 1100 also displays navigation information 1125 that corresponds to the information being displayed in the main panel section of the diagram 1100. This navigation information 1125 may be similar to the information stored in the favorite section if the user decides to save it.

The central backend management system 250 may be configured for proactive operation of a solar site and coordination between operators and field service personnel by remote control of the arrays. The central backend management system 250 may be configured for the user to request that an array or all of the arrays in a portfolio or a section to be put in normal tracking mode or another mode (e.g., stow mode). Responsive to the user's request to put the CPV array into the tracking mode, the array will move to the appropriate position and start tracking the sun. The central backend management system 250 may be configured for the user to request that an array or all of the arrays in the portfolio or a section be put in a hazard or stow mode from another mode when a condition exists (e.g., severe weather). The central backend management system 250 may be configured to enable the user to have the option to define a cushion in a time unit (e.g., minutes) after sunset and before sunrise that make up a night mode. The user may be able to define horizon parameters to control the array from starting to track too early or from stopping to track too late, based on the possibility that there is no direct sunlight due to horizon issues (e.g., neighboring mountain range).

The current to voltage (or IV) curves sub tab may be used to request IV curve data from the SCP 310. It may take approximately 60 seconds for the data from the SCP 310 to get to the central backend management system 250. There may be a progress indicator to provide the user an indication of the progress while the user is waiting for the IV curve data to be received by the central backend management system 250. When the IV curves sub tab is activated, the user may be able to view which paddles are included in a string when viewing the string performance. The user may be able to view the last IV curves taken for all of the strings of an array or all of the substrings of a string. The user may be able to view the value of parameters for an array's inverter control board.

When the IV curves sub tab is activated, the central backend management system 250 is configured for the option of generating an angle map for an array, at which point the array moves to each of the positions defined for the angle map and generates an IV curve. After finishing the sequence, the array will resume its correct position relative to the sun if it is in auto-tracking mode. The array may operate in auto or manual tracking mode. The central backend management system 250 may also generate an angle map for a specific paddle pair in the solar array. The central backend management system may 250 also generate an IV curve for the strings of an array or the substrings of a string. The central backend management system 250 may also show the set of geographical coordinates for a section and the array mapped to each. The central backend management system 250 may also generate the location of an array and its parameters within a section when viewing array performance.

The user may be able to request that a CPV array calibrate itself. The central backend management system 250 is configured for maximum performance and efficiency by allowing remote diagnostics and calibration upon the user request. When in the diagnostic mode, the user may be able to enter the roll and tilt position information for a CPV array, and then initiate a request for the CPV array to move based on that position information. The user may be able to issue a request to immediately turn on or turn off the strings of an individual CPV array.

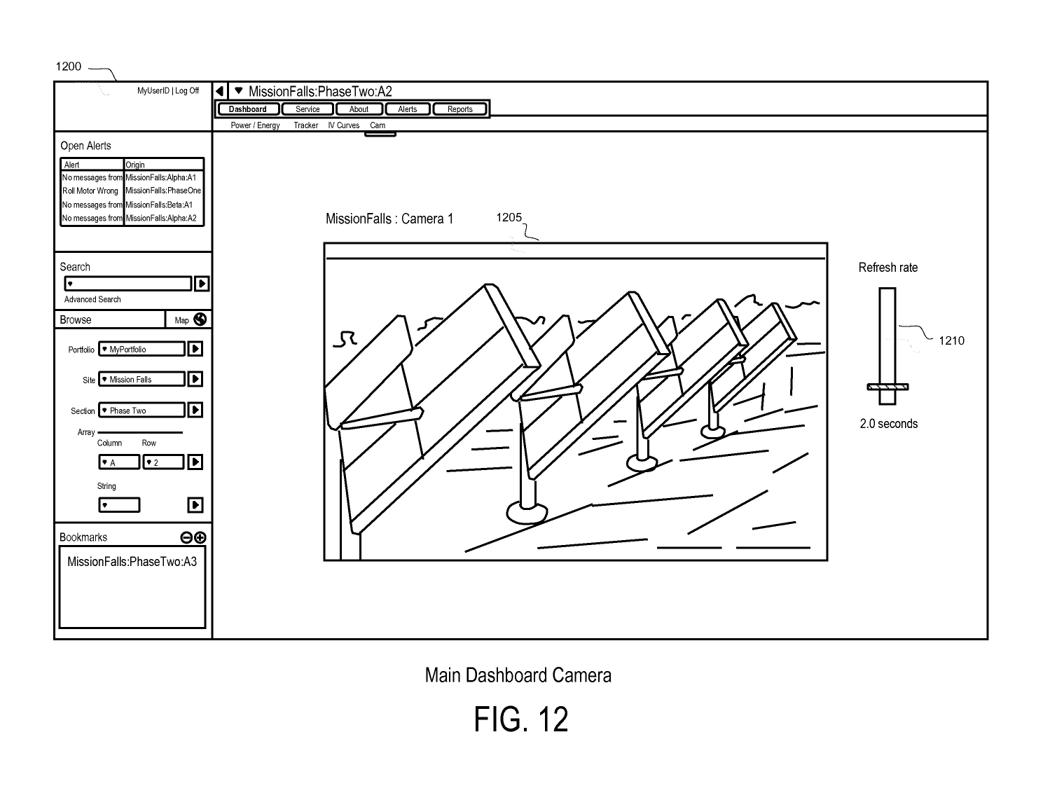

FIG. 12 is a diagram that illustrates an example main dashboard user interface that displays the camera information. Diagram 1200 may be presented when the camera sub tab under the dashboard tab is activated. The user may receive almost live video feed at all times via a video camera that is installed at the solar site. A large streaming video display area 1205 may enable the user to view at least a portion of the solar site. The user interface allows the user to enter a list of arrays or a single array that is to be monitored by the camera. The user interface may also have zoom options to enable the user to zoom in certain area of the solar site in near real time. The user may use the refresh option 1210 to change the camera refresh rate by moving the refresh slider. It may be noted that the diagram 1200 may be navigated to by selecting or clicking on the inset streaming video box 925 illustrated in FIG. 9.

The user may be able to access topological map of a solar site when viewing the performance information of the solar site. The user may be able to view the current settings for a CPV array including inverter and motor parameters, frequency of energy calculation, communication retry frequency in case of failures, etc. The dashboard may show performance of a portfolio, site, section, array or string with power versus DNI and current DNI, weather and projected power so that energy production levels can be analyzed in the context of existing conditions. The projected power may not include DNI calculations but may be based on the base specifications of all the components.

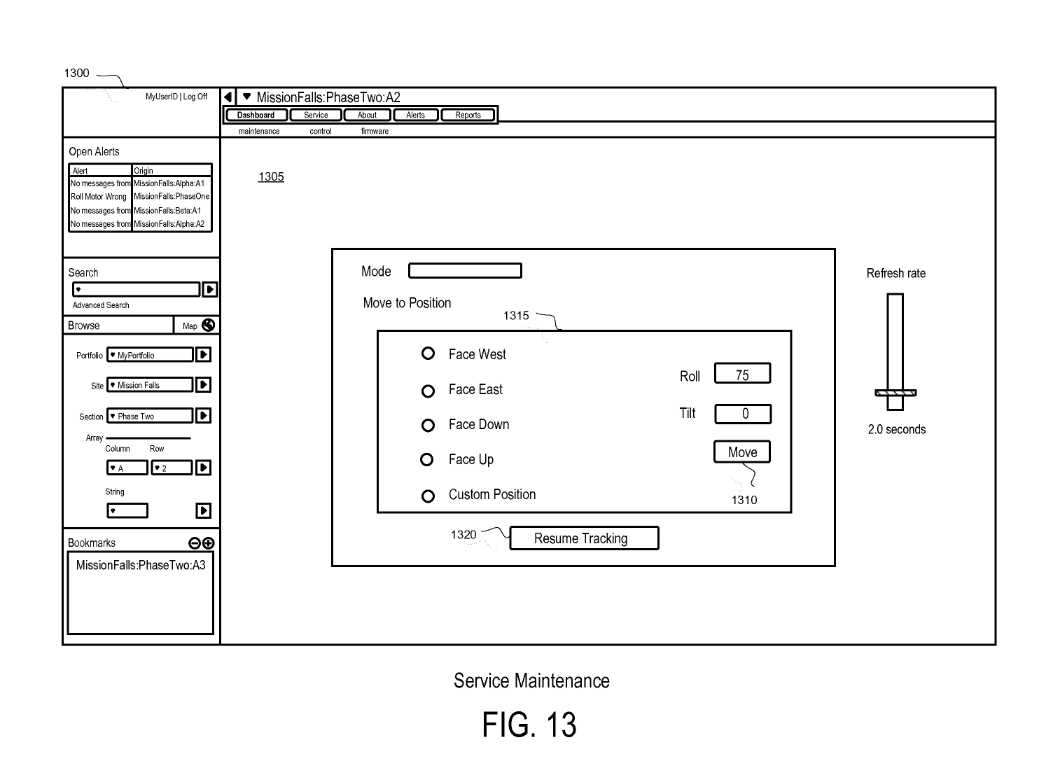

FIG. 13 is a diagram that illustrates an example main dashboard user interface that displays the maintenance information. Diagram 1300 may be presented when the service tab in the dashboard tab section 806 and its associated maintenance sub tab is activated. For some embodiments, this option may only be presented if the user is authenticated to perform service operations. Warning messages (e.g., pop-up windows) may be presented to ensure that the user understands that any operations performed by the user may change the energy production. As mentioned, the service tab includes a maintenance sub tab, a control sub tab and a firmware sub tab.

For some embodiments, when the service tab is activated, the maintenance sub tab is activated as a default. When the move button 1310 is selected or clicked, the CPV array may enter a manual mode. Current position information may be displayed in the tracking input section 1315. When the maintenance operation is complete, the resume tracking button 1320 may need to be selected or clicked to resume the energy production.

When the control sub tab under the service tab is activated, the user may be able to manipulate the array roll and each of the four tilt positions. The control sub tab may be used to assist in the initial leveling, referencing and calibrating of the roll and tilt axis of the CPV array. When the operations associated with the control sub tab is completed, the user may need to navigate back to the maintenance sub tab and select the resume tracking button 1320 to resume the energy production.

When the firmware sub tab under the service tab is activated, the user may be able to update the software packages for the array. As with the control sub tab, the user may need to navigate back to the maintenance sub tab and select the resume tracking button 1320 to resume the energy production.

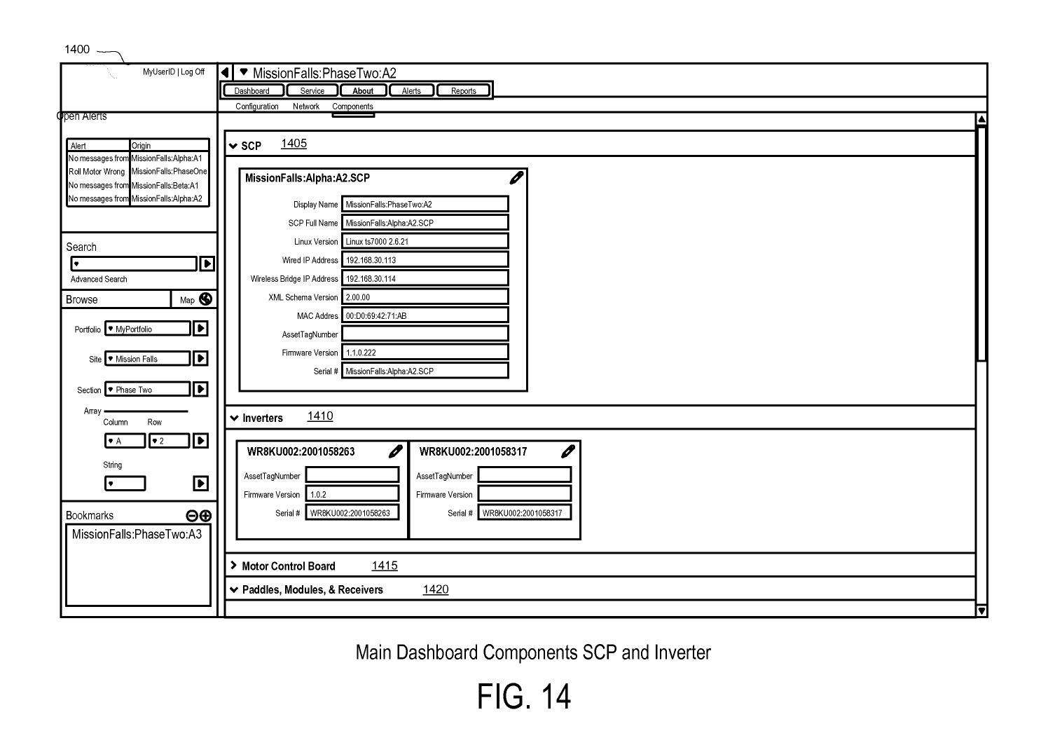

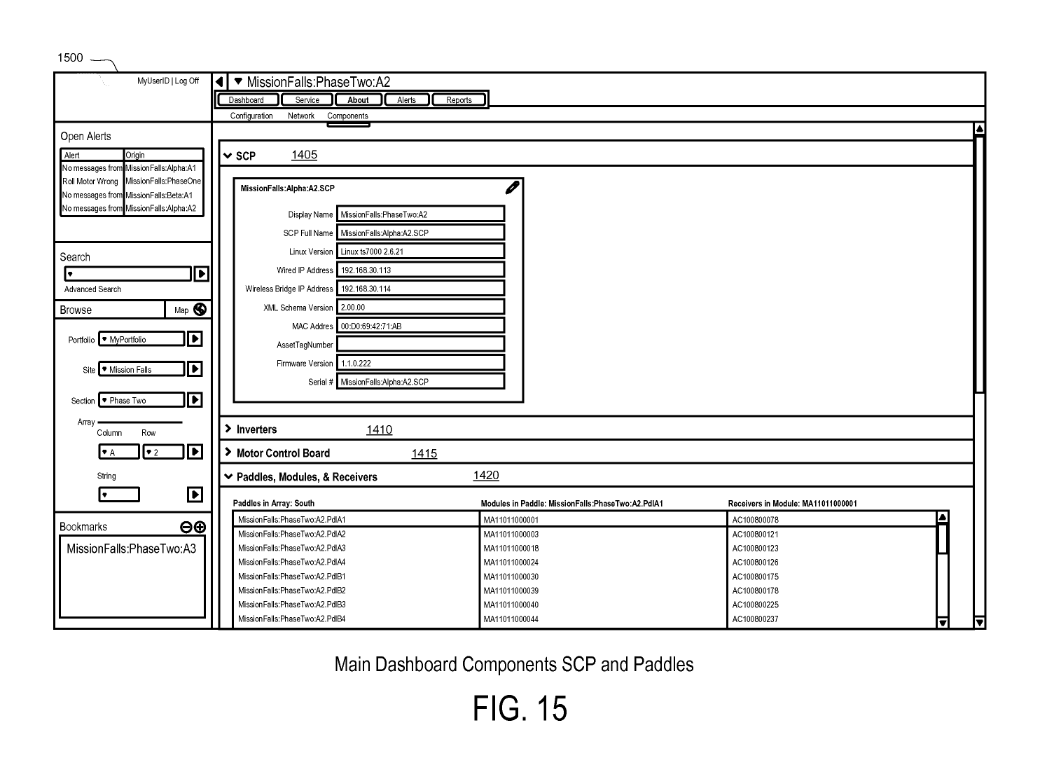

FIG. 14 is a diagram that illustrates an example main dashboard user interface that displays the component information. Diagram 1400 may be presented when the about tab in the dashboard tab section 806 and its associated component sub tab is activated. For some embodiments, activating the component sub tab may provide the user a view of the parameters of the CPV array. The view of the parameters of the CPV array may include the SCP view 1405, the inverter view 1410, the motor control board view 1415, and the paddle, module, and receivers view 1420. Each of these four views may be visible by selecting the appropriate heading. In the current example, the SCP view 1405 and the inverter view 1410 are illustrated. FIG. 15 is similar to FIG. 14 except it illustrates the SCP view 1405 and the paddle, module, and receivers view 1420. When the configuration sub tab is activated, current configuration information of the components of the CPV array may be presented in the main panel. When the network sub tab is activated, the network information may be presented.

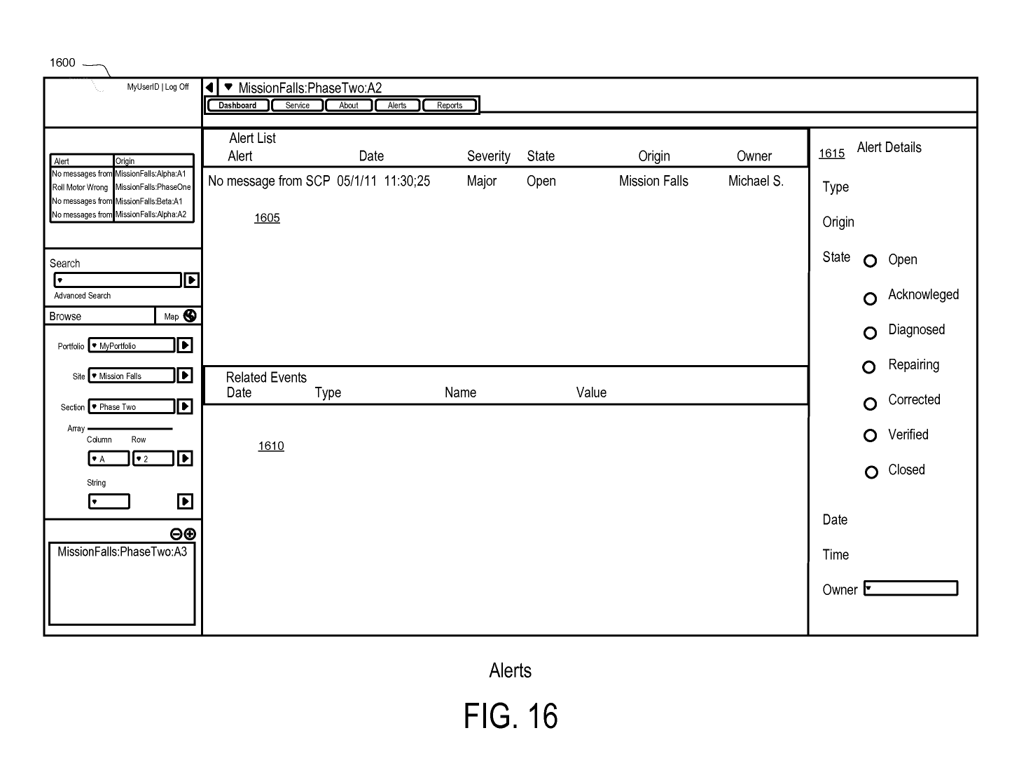

FIG. 16 is a diagram that illustrates an example main dashboard user interface that displays the alert information. Diagram 1600 may be presented when the alerts tab in the dashboard tab section 806 is activated. Diagram 1600 includes an alert list section 1605, an alert related events section 1610, and an alert details section 1615. Each alert in the alert list section 1605 is associated with a set of alert details displayed in the alert details section 1615. The alert details may include the status of the alert and the owner or person responsible for handling the alert. The alert list may display the severity of the alert, its origin, and the date and time when the alert is generated. The related events section 1610 may display other events that may be occurring when the alert is generated. This may help the user diagnose why the alert is generated and take the appropriate correction actions.

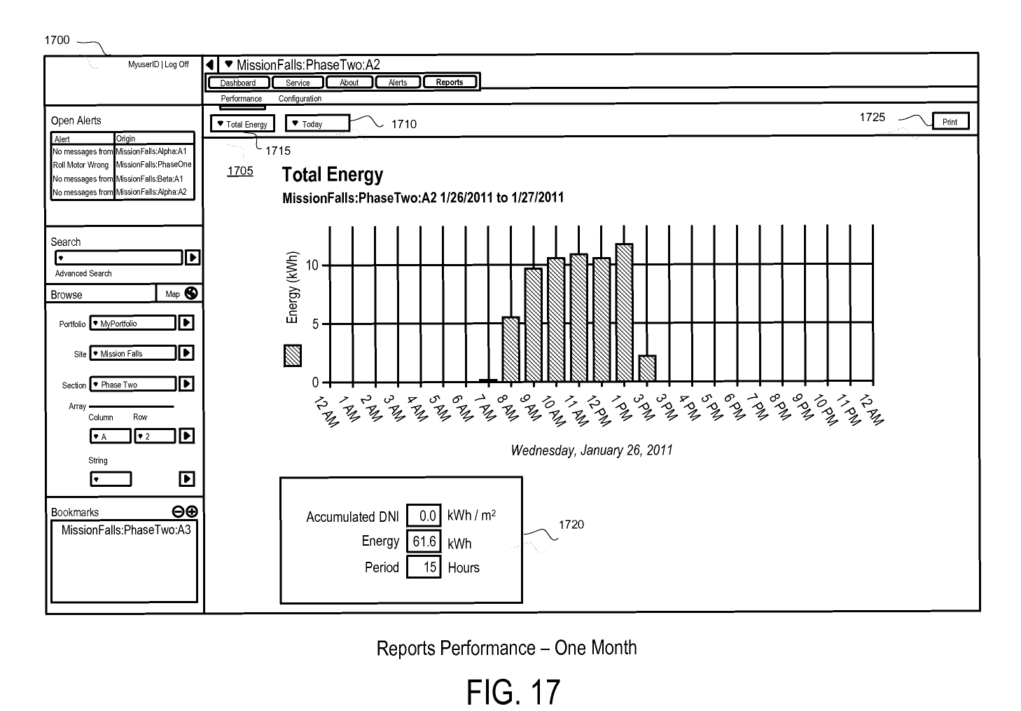

FIG. 17 is a diagram that illustrates an example main dashboard user interface that displays the performance information. Diagram 1700 may be presented when the reports tab in the dashboard tab section 806 and its associated performance sub tab is activated. Diagram 1700 may include a bar chart that displays total energy information for a particular timeframe. The timeframe may be changed by selecting the timeframe pull down button 1710. This may enable changing the timeframe from a day to a week, a previous week, a month, or can be set to a custom range. The bar chart may be changed to show the power and DNI information by selecting the pull down button 1715. A summary of the total energy and DNI information for the selected timeframe is displayed in box 1720. The user may use the print option 1725 to print a copy of the report.

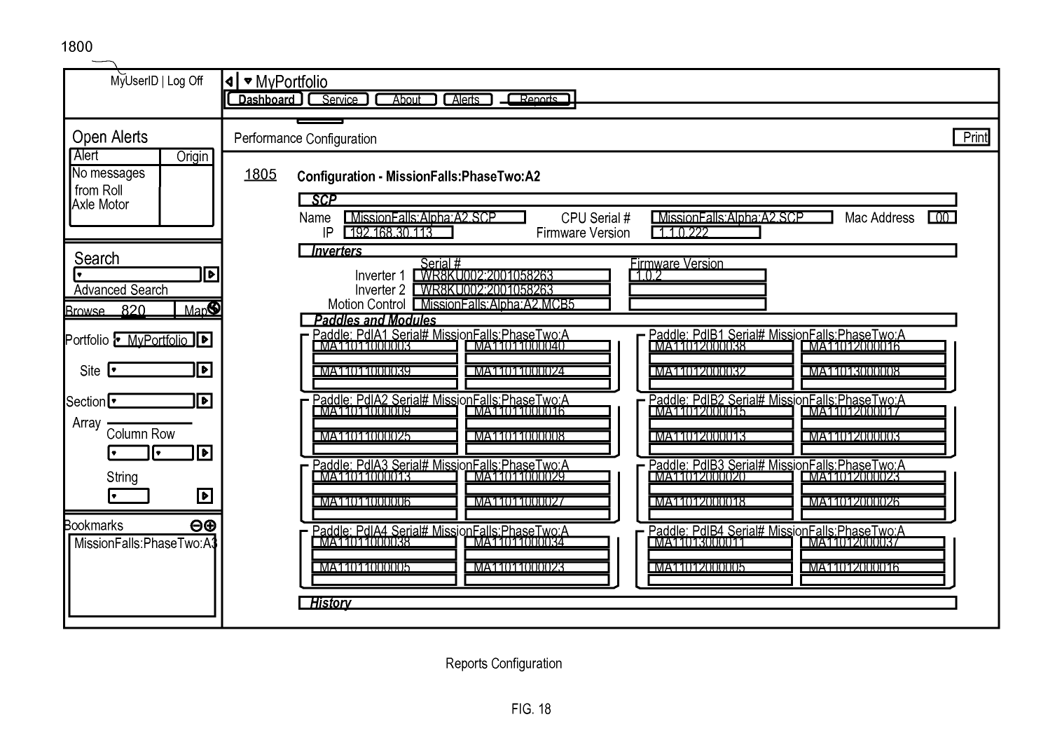

FIG. 18 is a diagram that illustrates an example main dashboard user interface that displays the configuration information. Diagram 1800 may be presented when the reports tab in the dashboard tab section 806 and its associated configuration sub tab is activated. Using this option, the user may be able to view how each component is configured, its serial number information, applicable firmware information, etc. As illustrated, the configuration information area 1805 may include configuration information for the SCP 310 (e.g., IP address, MAC address, serial number, etc.), the inverters (e.g., serial number, motion control, firmware, etc.), and the paddles, modules and receivers (e.g., serial numbers, etc.) in each of the arrays.

The reports tab may also include one or more sub tabs that enable the user to create and/or view standard or custom reports. The user may create custom reports using power, energy produced, DNI, and weather at the portfolio, site, section and array level. The user may have the option of filtering for specific portfolio, sites, sections, arrays or set. The user may be able to view the reports on the history of component changes for every component type (e.g., module, motor, SCP, mechanical component) or for all components. The user may view a standard weather and solar report. The user may view the manufacturing data, the performance information and the historical information (e.g., repair history) associated with a component. The user may also use this user interface to view other reports.

FIG. 19 is an example system diagram for a central backend management system. The system diagram 1900 includes client computing systems 1905 (e.g., wired and wireless devices) communicating with the central backend management system 250, which includes the internal logic 1930, the data warehouse 1925 (e.g., main storage, archive, backup), and external interfaces 1915. The external interfaces 1915 may be used to access external resources (e.g., web services, weather information, CRM, external applications, etc.) that may be necessary for the central backend management system 250 to operate. As mentioned, the central backend management system also receives information from the solar site 1920 via the SCP 310 over a secured connection.

The various user interface dashboards 1910 served to the client computing system 1905 from the central backend management system 250 may include a portfolio dashboard and a site dashboard. The user may also be able to access an array dashboard with daily, weekly, etc. view, an array dashboard on current to voltage (IV) curves (all strings or single string), an array tracking components dashboard, a string of CPV cells supplying DC voltage to an inverter dashboard, a visual browser including on-site camera dashboard, and many others. The dashboard for a portfolio, site, section, array, etc. may provide information about that element so that the user can select to control or monitor it for additional performance, manufacturing or configuration information.

The central backend management system 250 may be configured to operate as a hosting facility, which collects information from a number of parameters from all of the solar arrays at all of the solar sites. A user may only be able to access the information from the solar sites that the user is associated with. Communication between the central backend management system 250 and the solar sites may be performed using HTTPS.

When a new SPC and associated CPV array are installed in the solar site, the installation team may record the serial number of the SCP as well as the manufacturing data of all of the components of the associated CPV array. This may include, for example, the serial numbers of the inverters, the motors, the modules, etc. This may also include the manufacturing date and “as built” output voltage level of the modules since each of the modules may have a different output. Reference coordinate information (e.g., the latitude and longitude information) of the CPV array may also be determined. The information recorded by the installation team may be uploaded and stored in the database associated with the central backend management system 250.

When a new CPV array is installed in the field, it may need to be recognized by the central backend management system 250. The central backend management system 250 may identify the CPV array being commissioned by comparing its geographical coordinates to the reference coordinates. The central backend management system 250 may also map the SCP serial number received from the SCP 310 and the SCP serial number recorded by the field installation team to identify the paddles that are installed in the CPV array. Thus, the central backend management system can perform two or more mappings including: 1) using the Latitude and a Longitude information to identify each CPV array's geographical position in the set of arrays at the site relative to other CPV arrays located at that solar site; and 2) storing and recording in the database the serial number and the GPS coordinates from each two-axis tracker mechanism at the solar site to use any combination of the serial number and the GPS coordinates from a given two-axis tracker mechanism as identifiers for which two-axis tracker mechanism is sending a communication.

The central backend management system 250 may send configuration information to the SCP 310 and it can then start to monitor the SCP 310 and its associated CPV array. Thus, the central backend management system 250 sends auto-configuration files over the Internet to each of the two-axis tracking mechanisms installed at the solar site based upon the GPS coordinates of each of the two-axis tracking mechanisms and that two-axis tracking mechanism's relative position in the layout of the two-axis tracking mechanisms located at the solar site.

After the SCP 310 is configured, the central backend management system 250 may enable a user to observe what is happening to each of the components of the CPV array in the solar site. For example, the user may be able to compare actual performance data of the CPV array with the manufacturing test data to determine faulty parts. The user may be able to view the power data for the CPV array and the actual weather conditions at the solar site. The user may also be able to view the actual performance information and compare that with the projected information as determined by the manufacturer. The user may be able to compare parameters from the paddles of one CPV array to the parameters of paddles of neighboring CPV arrays.

### Solar Site Management Flow Diagram

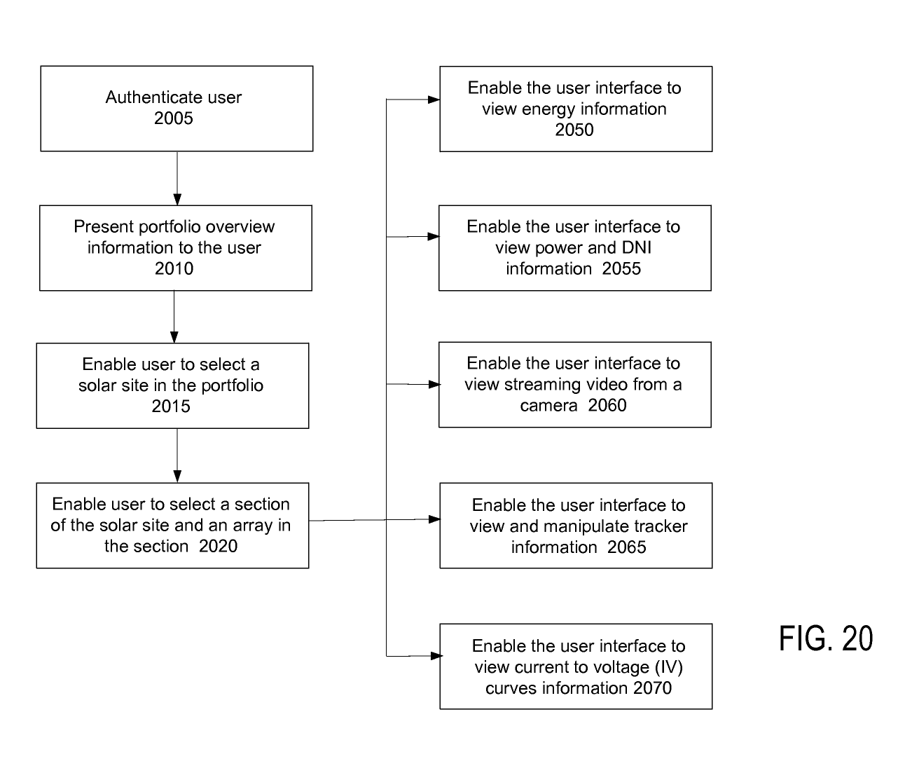

FIG. 20 is a flow diagram that illustrates an embodiment of a process that may be used to view performance-related information from a solar site. The process may include authenticating a user and presenting the user one or more interfaces as the user navigates to the various components using the browse options in the side panel 706. The process may start at block 2005 after the user is authenticated. At block 2010, the portfolio overview information associated with the user is presented. The portfolio overview information may include one or more solar sites that that user is authorized to view and/or manage. An example of the portfolio overview information is illustrated in FIG. 8.

The user may have the option to select one of the solar sites in the portfolio overview information, as shown in block 2015. The user may do this by using the site option in the browse section 720 illustrated in FIG. 9. At block 2020, the user is presented with options to select a section and an array in the section including the corresponding row and column. The user may do this by using the section, row and column options illustrated in the browse section 720 illustrated in FIG. 9. The user may then use the button 810 (illustrated in FIG. 8) to cause or refresh information displayed in the main panel.

As mentioned, the dashboard tab section 806 displays various options that may enable the user to view and/or modify information associated with the particular array that the user identified in operations associated with the blocks 2005-2020. The central backend management system 250 may present a user interface to enable the user to view energy information, as illustrated in block 2050 and in FIG. 9. The central backend management system 250 may present a user interface to enable the user to view power and DNI information, as illustrated in block 2055 and in FIG. 10. The central backend management system 250 may present a user interface to enable the user to view a streaming video, as illustrated in block 2060 and in FIG. 12. The central backend management system 250 may present a user interface to enable the user to view tracker information, as illustrated in block 2065 and in FIG. 11. The central backend management system 250 may present a user interface to enable the user to view IV curves, as illustrated in block 2070.

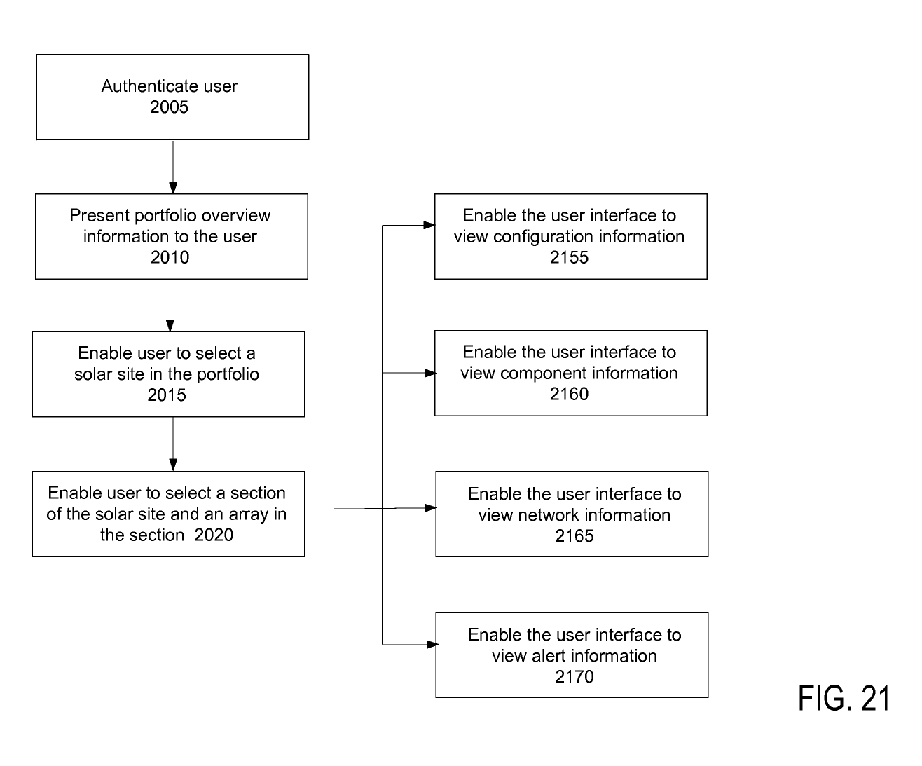

FIG. 21 is a flow diagram that illustrates an embodiment of another process that may be used to view configuration-related information from a solar site. The process in FIG. 21 may include the same steps 2005-2020 as the process illustrated in FIG. 20. At block 2155, the central backend management system 250 may present a user interface to enable the user to view configuration information. At block 2160, the central backend management system 250 may present a user interface to enable the user to view component information, as illustrated in FIGS. 14 and 15. At block 2165, the central backend management system 250 may present a user interface to enable the user to view network information. At block 2170, the central backend management system 250 may present a user interface to enable the user to view alert information, as illustrated in FIG. 16.

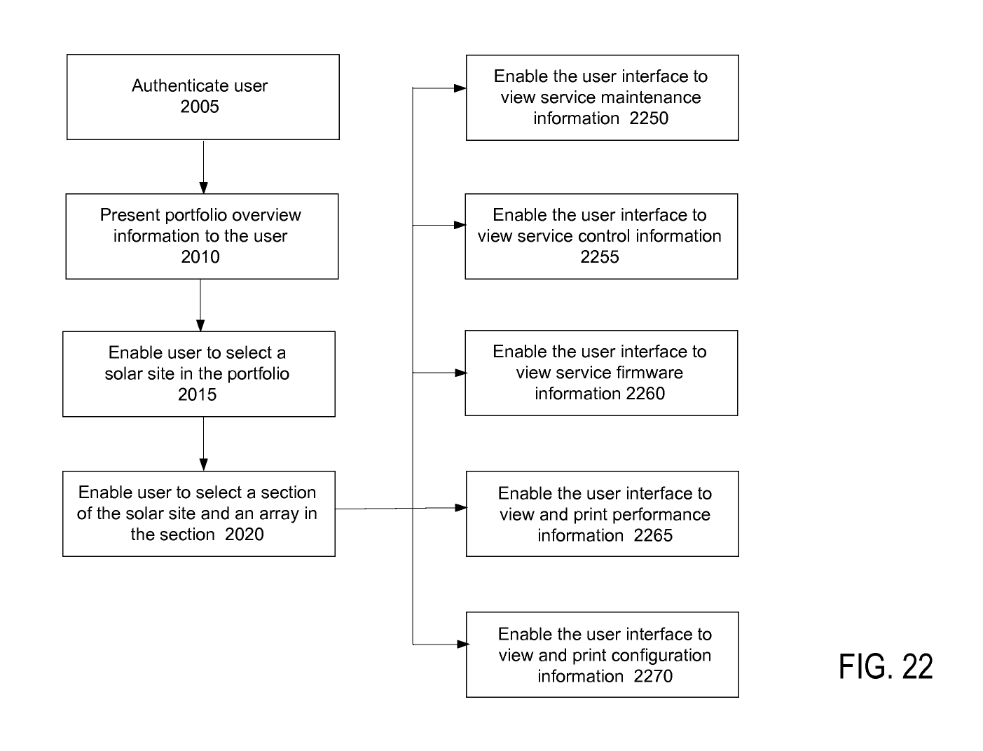

FIG. 22 is a flow diagram that illustrates an embodiment of another process that may be used to view service related information from a solar site. The process in FIG. 22 may include the same steps 2005-2020 as the process illustrated in FIG. 20. At block 2250, the central backend management system 250 may present a user interface to enable the user to view service maintenance information. At block 2255, the central backend management system 250 may present a user interface to enable the user to view service control information. At block 2260, the central backend management system 250 may present a user interface to enable the user to view service firmware information. At block 2265, the central backend management system 250 may present a user interface to enable the user to view and print performance information, as illustrated in FIG. 17. At block 2270, the central backend management system 250 may present a user interface to enable the user to view and print configuration information, as illustrated in FIG. 18.

It should be noted that, even though some of the operations described in the processes associated with FIGS. 20-22 refer to enabling the user to view the information associated with the solar site, for some embodiments, the user may also be able to perform some modification information. For example, when the user is authorized, the user may modify configuration information associated with one or more components of the solar site.

The central backend server management system allows manage the plant from a client device located anywhere. The central backend server management system offers sophisticated remote interactive capabilities. Client device access is available anywhere on the Internet and data is protected through the use of secure IP protocols.

The central backend server management system is a sophisticated, Internet-based, SaaS (software as a service) approach to power plant management that includes monitoring, diagnostics, and system control. Using the central backend server management system is easy and secure. The graphical user interface includes intuitive navigation, and locations can be bookmarked for quick and easy return. Simply login at the customer portal page to set roles and authorizations for each client's particular system. Monitor performance and take actions remotely, such as moving trackers, putting the system in stow mode, or resetting alarm or threshold limits.

The graphical user interface dashboards show system conditions and performance of the solar arrays. Client devices can monitor performance in real time at the plant level or drill down in the user interface to a single string. The GUI dashboard shows current conditions, performance, and live video. The central backend server management system monitors system performance using a database which contains factory test data for each component. If components such as modules, motors, or inverters are operating outside of specified limits, The central backend server management system will display on-screen alarms and can send text or email alerts to operators.

The system also monitors weather forecasts and site conditions. Powerful analytics included in the central backend server management system help pinpoint potential performance issues and identify appropriate actions for remedy, including maintenance and repair. The central backend server management system provides sophisticated solar plant management by providing alerts to conditions and events occurring at each solar array, and allows monitoring, diagnosis, and control of each solar array, so that system operation and maintenance is highly efficient and low-cost.

The central backend server management system provides reporting, monitoring, analysis, and notification. In addition to current performance, historical energy potential and actual generation can be displayed. Analysis is graphical and reports can be customized. The central backend server management system maintains and protects each client's data and because of the software as a service model used by the central backend server management system, a client device never has to conform to or worry about software version control and updating.

With reference to FIG. 1, for some embodiments, computing system environment 100 may be used by a client to access, control, and manage solar-related resources at one or more solar sites from a remote location. As will be described, the solar site may include many solar arrays, modules, paddles, tracker axis, etc. A client or user may use the computing system environment 100 to connect to a central backend management system over a network such as the Internet.

The computing system environment 100 is only one example of a suitable computing environment, such as a client device, and is not intended to suggest any limitation as to the scope of use or functionality of the design. Neither should the computing system environment 100 be interpreted as having any dependency or requirement relating to any one or combination of the illustrated components.

The design is operational with numerous other general purpose or special purpose computing system environments or configurations. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The design may be described in the general context of computing device executable instructions, such as program modules, being executed by a computer. Generally, the program modules include routines, programs, objects, components, data structures, etc., that perform particular tasks or implement particular abstract data types. Those skilled in the art can implement the description and/or figures herein as computer-executable instructions, which can be embodied on any form of computing machine readable media discussed below.

The design may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary computing type system for implementing the design includes a general-purpose computing device in the form of a computing device 110. Components of computing device 110 may include, but are not limited to, a processing unit 120 having one or more processing cores, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing device 110 typically includes a variety of computing machine-readable media. Computing machine-readable media can be any available media that can be accessed by computing device 110 and includes both volatile and nonvolatile media, removable and non-removable media. By way of example, and not limitation, computing machine-readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 110. Communication media typically embodies computer readable instructions, data structures, program modules, or other transport mechanism and includes any information delivery media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computing device 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computing device 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but they may be connected by other interface and bus structures, such as a parallel port, game port or a universal serial bus (USB). A monitor or display 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computing device 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing device 110. The logical connections depicted in FIG. 1 include a local area network (LAN) 171 and a wide area network (WAN) 173, but may also include other networks. Such networking environments are commonplace in offices, enterprise-wide computer networks, intranets and the Internet. A browser application may be resident on the computing device and stored in the memory.

When used in a LAN networking environment, the computing device 110 is connected to the LAN 171 through a network interface or adapter 170. When used in a WAN networking environment, the computing device 110 typically includes a communication module 172 or other means for establishing communications over the WAN 173, such as the Internet. The communication module 172 may be a modem used for wired, wireless communication or both. The communication module 172 may be internal or external, may be connected to the system bus 121 via the user-input interface 160, or other appropriate mechanism. In a networked environment, program modules depicted relative to the computing device 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present design can be carried out on a computing system such as that described with respect to FIG. 1. However, the present design can be carried out on a server, a computer devoted to message handling, or on a distributed system in which different portions of the present design are carried out on different parts of the distributed computing system.

Another device that may be coupled to bus 111 is a power supply such as a battery and alternating current (AC) adapter circuit. As discussed above, the DC power supply may be a battery, a fuel cell, or similar DC power source that needs to be recharged on a periodic basis. For wireless communication, the communication module 172 may employ a Wireless Application Protocol to establish a wireless communication channel. The communication module 172 may implement a wireless networking standard such as Institute of Electrical and Electronics Engineers (IEEE) 802.11 standard, IEEE std. 802.11-1999, published by IEEE in 1999.

While other systems may use, in an independent manner, various components that may be used in the design, a comprehensive, integrated system that addresses the multiple advertising system points of vulnerability described herein does not exist. Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

Although the foregoing embodiments have been described in some detail for purposes of clarity of understanding, the invention is not limited to the details provided. Functionality of circuit blocks may be implemented in hardware logic, active components including capacitors and inductors, resistors, and other similar electrical components. There are many alternative ways of implementing the invention. The disclosed embodiments are illustrative and not restrictive.

We claim:

1. A method for enabling access to information associated with a concentrated photovoltaic (CPV) array installed in a solar site having multiple CPV arrays, the method comprising:
receiving information from a user indicating that the user wants to view information related to a plurality of concentrated photovoltaic (CPV) arrays located at a remote solar site, each of the CPV arrays is coupled with a different system control point (SCP) communicatively connected to a central backend management system using an Internet, the information received from the user including authenticating information and based on the user using a browser in a client computing system communicatively connected to the central backend management system via the Internet;
based on the authenticating information having been verified and based on confirming that the user is allowed to view the information related to the plurality of CPV arrays located at the remote solar site:
presenting a set of user interfaces viewable with the browser to allow a user to drill down and then view and interact with more specific components;
presenting first a user interface viewable with the browser where the first user interface includes overview information of one or more solar sites included in a portfolio that the user is associated with;
presenting a second user interface viewable with the browser where the second user interface includes options to enable the user to specify the remote solar site in the portfolio and a component of the solar site that the user wants to view the information of; and
responsive to the user specifying the portfolio and the component, presenting a third user interface viewable with the browser where the third user interface is to display information related to the specified component.

2. The method of claim 1, wherein the information related to the specified component comprises performance information of a CPV array.

3. The method of claim 1, wherein the information related to the specified component comprises current to voltage (IV) curves for one or more strings in a CPV array.

4. The method of claim 1, wherein the information related to the specified component comprises power and direct normal irradiation (DNI) information for one or more strings in a CPV array.

5. The method of claim 1, wherein the information related to the specified component comprises tracking information of a CPV array.

6. The method of claim 1, wherein the information related to the specified component comprises performance information of a string in a CPV array.

7. The method of claim 1, wherein the information related to the specified component comprises configuration information of a string in a CPV array.

8. The method of claim 1, wherein the information related to the specified component comprises streaming video captured by a camera located at the remote solar site.

9. The method of claim 1, wherein the information related to the specified component is transmitted to the central backend management system by a system control point (SCP) located at the remote solar site and stored in a database associated with the central backend management system.

10. The method of claim 1, further comprising:
based on the authenticating information having been verified, presenting a fourth user interface viewable with the browser, where the fourth user interface is to display a search option and a favorite option, the search option enabling the user to search for information related to the remote solar site and the favorite option enabling the user to save a link to information related to the remote solar site.

11. The method of claim 1, further comprising:
based on the authenticating information having been verified, presenting a fifth user interface viewable with the browser where the fifth interface is to display configuration information and manufacturing data of the specified component of the remote solar site.

12. A concentrated photovoltaic (CPV) array management system, comprising:
a central backend management system configured to communicate with a plurality of concentrated photovoltaic (CPV) arrays located at a solar site, where each of the CPV arrays is coupled with a different system control point (SCP) that communicatively connects to the central backend management system associated with that solar site, wherein communications between a given SCP and the central backend management system are configured to use a secure communication channel protocol which verifies the identity of both the central backend management system and the SCP,
wherein the central backend management system is configured to present a plurality of user interfaces via an Internet to a browser of a user's client device to enable the user to navigate to and then 1) view information for various components, 2) send a command to perform an action for various components, and 3) any combination of both for the various components associated with the CPV arrays, and
wherein the plurality of user interfaces are viewable with the browser and are then presented on a display of the client device based on the central backend management system having authenticated the user as being allowed to view the information related to the CPV array.

13. The system of claim 12, wherein the CPV array is contained on a multiple-axis tracker mechanism, wherein the multiple-axis tracker mechanism includes a housing for the SCP, and wherein the central backend management system is configured to present a first user interface viewable with the browser to enable the user to view information related to the two-axis tracker.

14. The system of claim 13, wherein the central backend management system is configured to present a second user interface viewable with the browser to enable the user to view performance information related to electrical power generating circuitry associated with the SCP.

15. The system of claim 12, wherein the CPV array is associated with a global positioning system (GPS) circuitry and a video camera, and wherein the central backend management system is configured to present a third user interface viewable with the browser to enable the user to view a streaming video captured by the video camera.

16. The system of claim 15, wherein the central backend management system is configured to present a fourth user interface viewable with the browser to enable the user to view position information of the CPV array at the solar site as generated by the GPS circuitry.

17. The system of claim 12, wherein the central backend management system is configured to present a fifth user interface viewable with the browser to enable the user to view direct normal incidence (DNI) and local weather information associated with the solar site.

18. A computer-readable media that stores instructions, which when executed by a machine, cause the machine to perform operations comprising:
authenticating a user based on identification and password information sent from a client computer system by the user via a browser and an Internet connection, wherein said authenticating is performed by a central backend management system connected to the Internet;
receiving information from the user indicating that the user wants to access information related to a plurality of concentrated photovoltaic (CPV) arrays associated with the user, the CPV arrays located at a remote solar site, each of the CPV arrays is coupled with a different system control point (SCP) communicatively connected to the central backend management system;
presenting a first user interface viewable with the browser to display options that enable the user to specify a component of a CPV array in the plurality of the CPV arrays; and
presenting a second user interface viewable with the browser to display information related to the component of the CPV array that the user specified using the first user interface.

19. The computer-readable media of claim 18, wherein the information related to the specified component of the CPV array includes one or more of performance information of a string in the CPV array, current to voltage (IV) curves of the string in the CPV array, configuration information of the string in the CPV array, and power and direct normal irradiation (DNI) information of the string in the CPV array.

20. The computer-readable media of claim 18, wherein the information related to the specified component of the CPV array includes one or more of streaming video captured by a camera associated with the CPV array, weather information where the CPV array is located, tracking information of the CPV array, and performance information of the CPV array.
